(19) United States
(12) Patent Application Publication
(10) Pub. No.: US 2007/0208764 A1
(43) Pub. Date: Sep. 6, 2007

(54) Universal information platform

(76) Inventor: John Edward Grisinger, Fair Oaks, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/714,664

(22) Filed: Mar. 5, 2007

Related U.S. Application Data
(60) Provisional application No. 60/779,807, filed on Mar. 6, 2006.

(51) Int. Cl. G06F 7/00

(52) U.S. Cl. 707/100

(57) ABSTRACT

Information is stored in a data structure as an item element and an association element. The item comprises a content attribute. The association comprises a count attribute and a sign attribute, and represents a relationship between two items. The data structure itself is an occurrence of a storage model that conforms to axioms of information that define characteristics common to all forms of information. The elements of the data structure can be added, deleted and/or edited and such modifications of the data structure are validated before being applied. Explicit and implicit constraints are also enforced during modification. An item can represent a factual or an expectational object. Informational processes may be executed to generate real objects from corresponding expectational objects. An association element has a directionality representing the creation sequence of the items it associates. Output from the data structure is generated in response to a query.

### RELATED APPLICATIONS

This application claims the benefit of U.S. provisional application Ser. No. 60/779,807 filed on Mar. 6, 2006, which is herein incorporated by reference.

### FIELD OF THE INVENTION

This invention related generally to information management and more particularity to a specific storage model for information.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2006, Vara Data Systems, All Rights Reserved.

### BACKGROUND

The management of information is currently beset by problems across all its fields and deeply within each of those fields. The root of this problem can be traced to the fact that there is no foundational understanding of the nature of information. The reason for this is most likely the inability to overcome the differences in the analysis techniques, terminology and how information is expressed (e.g., tables, pictures, equations, logic statements and written language). Those differences tend to hide commonalities that might hint at the existence of a foundational understanding.

In the field of computer science, the depth of the problems is particularly keen because of the complexities found therein. The differences in the manner of machine representation of information also hide any commonalities (e.g., structured and unstructured data in innumerable formats, and software in a growing variety of languages and versions thereof). Within computer science, the foundational understanding of information is limited to the following:

a generally understood, but usually unstated, recognition that information is ultimately atomic and that atomic nature is found at different levels (bits, byte representations, e.g., an ASCII character or a pixel, numbers and other indivisible organizations of data generally referred to as content);

information theory for transmission of information over a noisy channel; and

relational model and query language based on predicate logic.

The absence of a robust foundational understanding of information has resulted in the following specific problems with the management of information. For the information sciences as a whole, there is no common language or illustration convention for describing information. For computer science, the problems are as summarized below.

The rigor found in mathematics is not found in computer science. The developer of an application is generally unconstrained by any principles that arise from a foundational understanding of information. For example, database application developers are free to deviate from relational theory.

There has been a proliferation of one-off problem-specific storage platforms for specific forms of information, both structured data (e.g., files, databases and software), and unstructured data (e.g., text and video), each usually inconsistent with the others. There has been a similar proliferation of languages and versions thereof as well.

Large information systems require significant effort and time to design and build. In addition to the cost associated therewith, this has resulted in the larger organizations having multiple small incompatible systems with fragmented and redundant information.

Shared information must be converted from one format to another, often with loss of information.

The conventional techniques used to store structured information cannot specify: a range of possibilities; uncertainty; complex numeric expressions (including exact fractions) or distributions.

Many of the terms used in computer science have a variety of meanings (e.g., object) and some terms are ambiguous (e.g., entity).

Each technique for storing structured information allows some information to be omitted (e.g., absence of units of measure), thereby requiring the use of additional storage techniques (e.g., a written file format specification and system documentation). As a result structured information requires the use of multiple storage techniques, for example, a relational database requires the use of tables, a schema, screens, software and various forms of documentation to fully convey information stored.

There are a growing number of systems containing useful information that were built using older technology are unsupported and may lack adequate documentation, with the possibly that the information therein may be lost.

### SUMMARY

Information is stored in a data structure as an item and an association. The item comprises a content attribute. The association comprises a count attribute and a sign attribute, and represents a relationship between two items. The data structure itself is an occurrence of a storage model that conforms to axioms of information that define characteristics common to all forms of information. The elements of the data structure can be added, deleted and/or edited and such modifications of the data structure are validated before being applied. Explicit and implicit constraints are also enforced during modification. An item can represent a factual or an expectational object. Informational processes may be executed to generate real objects from corresponding expectational objects. An association is a non-configuration association if it specifies the relationship between two items with different item subtypes, or a configuration association if it specifies the relationship between two items with the same item subtype. An association also has a directionality defined by the creation sequence of the items on each end. Output from the data structure is generated in response to a query.

The present invention is described in conjunction with systems, computers, methods, and computer-readable media of varying scope. In addition to the aspects of the present invention described in this summary, further aspects of the invention will become apparent by reference to the drawings and by reading the detailed description that follows.

### DESCRIPTION OF THE DRAWINGS

FIGS. 1A-B illustrate the I-A storage model.

FIGS. 2A-B illustrate two expanded forms of the item-association model with element subtypes.

FIGS. 3A-C illustrate non-generic example non-configuration structures using different illustration conventions.

FIGS. 4A-C illustrate generic example configuration structures using the configuration association illustration convention.

FIGS. 5A-B illustrate generic example instance structures specifying the same configuration of common instances.

FIGS. 6A-B illustrate non-generic example instance configuration structures with common instances.

FIGS. 7A-F illustrate non-generic example configuration structures specifying duplication, identity and reality.

FIGS. 8A-B illustrate concept hierarchy pattern and non-generic example class hierarchy structure for motor vehicle.

FIG. 9 illustrates example class structures for highway vehicle with two hierarchies.

FIGS. 10A-B illustrate generic example concept structure using different illustration conventions.

FIG. 11 illustrates a generic example concept structure with comparison of concepts.

FIGS. 12A-G illustrate configuration patterns based on concept comparison.

FIGS. 13A-D illustrate generic example structures that identify item subtypes.

FIG. 14 illustrates a generic example configuration structure with expression types.

FIGS. 15A-D illustrate generic example configuration structures with expressions for simultaneously-configured and uniquely-configured structures for definition and production associations.

FIGS. 16A-D illustrate generic example sequentially configured instances structures with expressions.

FIGS. 17A-F illustrate non-generic example configuration structures with item expressions.

FIG. 18 illustrates generic example of instance structures with different uncertainties.

FIGS. 19A-B illustrate generic examples of uniquely-configured structures with 1-end association and inverse item expressions.

FIGS. 20A-C illustrate non-generic example uniquely-configured summation structures with 1-end association and inverse item expressions.

FIGS. 21A-B illustrate non-generic example sequentially-summed instance structures with expressions.

FIGS. 22A-B illustrate generic example diverging instance structures with expressions.

FIG. 23 illustrates a non-generic example value structure for a portion of the Length value domain.

FIG. 24 illustrates a generic example value structure for a portion of the Time value domain.

FIG. 25 illustrates a non-generic example sum/portion object structures with state interval objects specifying different values.

FIG. 26 illustrates a process pattern.

FIGS. 27A-C illustrate generic example expectational object production structures.

FIGS. 28A-B illustrate non-generic example expectational and factional object structures.

FIG. 29 illustrates a generic example expectational process structure that generates a new object.

FIGS. 30A-C illustrate generic example structures before and after the execution of a logical process.

FIG. 31 is a flowchart for one embodiment of the I-A platform management system.

FIG. 32 is a flowchart for one embodiment of an add, delete and edit elements method.

FIG. 33 is a flowchart for one embodiment of an execute an information process method.

FIG. 34 is a flowchart for one embodiment of a get and validate elements method.

FIGS. 35 and 36 are flowcharts for one embodiment of a get and validate concept method.

FIGS. 37 and 38A-C are flowcharts for one embodiment of a get and validate object method.

FIG. 39 is a flowchart for one embodiment of a duplicate/query method.

FIG. 40 is a flowchart for one embodiment of an enforce explicit constraints method.

FIG. 41 illustrates modules that implement the methods of the invention.

FIG. 42 is a diagram of one embodiment of a computer system suitable for use with the invention.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. In addition, in order to aid understanding of the invention, a Table of Contents of the Detailed Description is provided. The following detailed description is, therefore, not to be taken in a limiting sense, and the scope of the present invention is defined only by the appended claims.

### Table of Contents

I. Glossary
II. Overview
   A. I-A Platform
   B. I-A Storage Model
   C. Axioms of Information
   D. Element Subtypes
      1. Element Subtypes based on Classification And Attribution
      2. Element Subtypes based on Content
III. Structures
   A. Non-configuration Structures
   B. Configuration Structures
   C. Elements Subtypes
      1. Instance Subtypes based on Atomicity
      2. Instance Subtypes based on Item Identification
      3. Duplicate and Identical Items
      4. Item Reality
   D. Concept Structures
      1. Concept Hierarchies
      2. Concept Structure with Identity Network
      3. Combined Class and Metric Structure
   E. Concept Comparison and Resulting Element Subtypes
      1. Concept Comparison
      2. Configuration Association Subtypes Based on Concept Comparison
      3. Configuration Patterns Based on Concept Comparison
      4. Instance Subtypes Based on Configuration Patterns
IV. Expressions
   A. Expression Types
      1. Initial Expression
      2. 0-end Association Expression
      3. Item Expression
      4. 1-end Association Expressions and Inverse Item Expressions
   B. Illustrating Expressions in Grid Form
V. Complex Information Structures
   A. Value Specification
   B. Time Value Domains
   C. Spatial Value Domains
   D. Value and Membership Variation
   E. Processes
   F. Constraints
      1. Implicit Constraints
      2. Explicit Constraints
   G. Expectational Processes
   H. Specifying a Query
VI. Management System
   A. Add, Delete and Edit Elements Method
   B. Execute an Informational Process Method
   C. Determine Element Subtype Method
   D. Get and Validate Concepts Method
   E. Get and Validate Object Method
   F. Duplicate/Query Method
   G. Enforce Explicit Constraints Method
VII. Operating Environment
VIII. Conclusion

### I. Glossary

In order to avoid problems of inconsistent and ambiguous terminology described above (e.g., object and entity, respectively), a glossary of terms as used herein is presented.
1. association—an element subtype that is a logical construct that directionally associates (or relates) two items or one item with itself; it is the most resolved unit of organization
2. attribution value—a value that has an object attribution association
3. axiom of information—an observation about information that is regarded as always true for all forms of information
4. class—a concept that classifies and is attributed
5. common instance—a representational instance subtype that represents any instance or multiples thereof among those that, while unique, are individually indistinguishable from one another
6. concept—an item subtype that is a classifier
7. configuration association—an association between two items with the same item subtype
8. content (a)—an attribute of an item storing a string of bits of any length including the absence any bits
9. count (n)—an attribute of an instance configuration association storing how many 1-end items are associated (with the specified sign and directionality) with the 0-end item, or ignorance thereof
10. current object—a factual object with an implied end Time value of ‘Now’
11. data—an occurrence of element attributes; content, sign and count are the three types of data (element attributes) defined in the I-A storage model
12. defined item—an item subtype that represents a grouping of one or more items, i.e., non-atomic; it is a logical construct not otherwise found in the real world (its mathematical counterpart is a set)
13. duplicate item—an item that is a defined by another item as a subsequent item
14. element—an atomic unit of information that is either an item or an association
15. expectational object—an object that has its existence specified with respect to the ‘Now’ Time value domain with a start Time value of ‘Now’ or later than ‘Now’; such an object represents an object that could exist in the future
16. expression—a text string resembling an arithmetic/algebraic expression that describes the information conveyed by an element in the context of a structure
17. factual object—an object that has its existence specified with respect to the fixed Time value domain with a start Time value later than ‘Now’
18. fixed time sub-domain—the time value domain specified relative to an event object whose temporal existence is known, e.g., the birth of Christ
19. future object—an factual object with a start Time value later than ‘Now’
20. generic example structure—a description of a range of non-generic example structures illustrated in a diagram using parameters for attributes, encompasses a range of possible elements, or its elements are supertypes (e.g., instance) or some combination thereof
21. identical items—two or more items other than internal instance can represent the same thing
22. identity network—a structure form by three or more items specified as identical
23. identity association—the combination of two configuration associations specifying that two items are identical
24. information structure (structure)—items interconnected by associations that convey information
25. informational process—a process that specifies inputs and outputs that do not represent physical objects
26. instance—an item that is classified, the instantiation of a concept
27. internal instance—an instance storing a non-empty bit string
28. item—an element subtype that is a logical construct that represents something and that may store relevant content
29. item_id—an arbitrary unique identifier that identifies an item
30. leaf item—an item that has no 0-end configuration associations and one or more 1-end associations
31. member instance—an instance configuring a product instance
32. metric—a concept subtype that classifies and attributes
33. metric unit value—a value in a value domain that represents a finite amount that value presumed to be at or smaller than some threshold of observability
34. non-configuration association—an association between two items with different item subtypes
35. non-generic example structure—a structure illustrated in a diagram that could be stored as illustrated
36. now time sub-domain—the time value domain specified relative to the present moment in time (i.e., ‘Now’)
37. object—an instance subtype that is classified and is attributed
38. particular instance—a representational instance that represents something that is uniquely identified so as to be distinguishable from all others
39. pattern—a description of multiple possible structures, illustrated in a diagram, that convey a name type of information using parameters for attributes, encompasses a range of possible elements, or its elements are supertypes (e.g., instance) or some combination thereof
40. process object—An object whose members are input objects and output objects, and one or more object starts or ends its temporal existence during the process
41. product instance—a specific (atomic) instance that is configured by other instances
42. real item—an item other than an internal instance that represents something in the real world
43. reality (r)—a characteristic of an item that arises from a configuration association that include the item in itself that specifies the item as being a real item, a virtual item or an uncertain item
44. representational instance—an instance that represents something external to the information system
45. root item—an item that has one or more 0-end configuration associations and no 1-end associations
46. seed item—an item that has no 0-end configuration associations and no 1-end associations
47. sign (s)—an attribute of an configuration association storing whether the 1-end item is included or excluded from the 0-end item, or ignorance thereof
48. spatial existence—the interval in space where an object exists specified by dimension-specific Length values
49. specific item—an item subtype that represents something that is indivisible, i.e., atomic
50. stem item—an item that has one or more 0-end configuration associations and one or more 1-end associations
51. storage model—a description of the attributes and the organization of those attributes as a means of storing information
52. system process—a process that is part of an I-A platform and applicable to all information stored therein
53. temporal existence—the interval in time where an object exists specified by Time values
54. uncertain item—an item other than an internal instance about which we are ignorant of whether an item is real or virtual item
55. value—an instance subtype that is classified and attributes
56. value domain—a structure specifying the ranges of values that apply to an object for a given metric in terms of one or more objects whose values are used as a reference
57. virtual item—an item that represents something that is not a real world item

### II. Overview

A system is described for managing information that arises directly from, and is fully consistent with, the axioms of information. Those axioms, listed below, are observations about information that are regarded as always true for all forms of information. Since those axioms are not specific to a particular form of information (e.g., databases or software), this system is applicable to all forms of information and provides a foundation for understanding all forms of information.

### A. I-A Platform

The system is implemented on an I-A platform (for information axiom) in which information is conveyed by items interconnected through associations. Items interconnected in this manner is referred to as an information structure or simply structure. A structure can be of any complexity. A structure can be described by a pattern, each pattern being specific to a type of information, e.g., class hierarchy is a type of information and class hierarchy describes the information conveyed by any elementary structure matching that pattern. Interconnected elements can store constraints. System processes can enforce these constraints by comparing them to information proposed for entry and rejecting inconsistent information. Interconnected elements can store both physical and informational processes. System processes can execute informational processes to create elements specified as output from those information processes.

The concepts and rules common to all information are a component of an I-A platform and can include such information as synonyms, abbreviations, alternate spellings, and can be in any or multiple languages. The forms of information that may be stored in an I-A platform include: complex taxonomies/ontologies, object classification/attribution (i.e., database information) generalization/specialization hierarchies, whole/part composition, value domains with their units of measure, spatial configuration, vectors, number types (e.g., exact, inexact and irrational), uncertainty, unknowns, synonyms, identity networks, basic mathematical and statistical expressions, distributions, logic expressions, sequence (i.e., order), unstructured data, and logical processes (both physical and informational) stored as structures, and procedures that can be executed by a system process.

System processes manage information entered into an I-A platform. These processes implement various techniques that provide the functionality needed to input and output information, validate information and execute logical processes stored as structures. Validation enforces both constraints that are applicable to all information, usually specific to an axiom, and those that are specific to an application and specified by an information structure.

### B. I-A Storage Model

A specification of how information is stored in given form (i.e., a text document, database, etc.) is an information storage model, one example being the relational model. A specific storage model, the I-A storage model, is implemented by an I-A platform.

Some of the characteristics of information are described by set theory, specifically inclusion. The counterpart to the I-A storage model in set theory are: a set is a defined object whose class is ignored; the members of the set are the defining objects (which can themselves be defined); and the associations that include the defining objects are specification of that inclusion.

The organization of information can be described using graph theory. The counterparts to the I-A storage model in graph theory are: a vertex is an item; and an association is an edge. However, there are various graph theories, each specific to a single graph type (e.g., directed acyclic) and a structure can have several different graph types because some associations (edges) have attributes and others do not, and some associations (edges) are directed and others are not. Thus no one type of graph theory is capable of describing a structure.

However, the elements in a structure have the following additional features needed to convey information that are not found in either theory: content, inclusion and exclusion, counts, reality (discussed subsequently), values; common vs. particular objects, to name a few.

Given that set theory and graph theory are each limited in its ability to describe information, those theories are not useful as a means of describing information in general. Instead, the description herein develops graphic and text illustration conventions and uses them to describe the I-A storage model and structures, and to present generic and non-generic examples of its application.

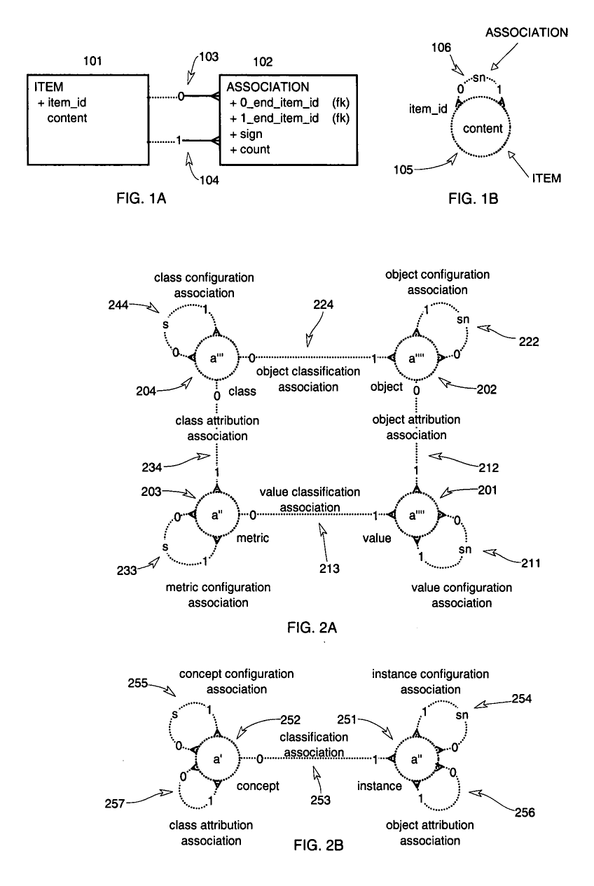

The I-A storage model is based on the axiom that information can be specified by directionally associating items. The elements of the I-A storage model are shown in FIGS. 1A-B, which are described below. The I-A storage model comprises two elementary units of information, i.e., elements, an item and an association. This storage model has important and unique characteristics: (1) having the fewest components, it is simplest possible storage model; (2) each component is independent of the other; and (3) it is simultaneously a very simple relational model and a very simple network model.

An item stores a content attribute, abbreviated by the parameter a, and is uniquely identified by an arbitrary unique identifier (item_id) that identifies the item among all items simultaneously accessible to an I-A platform. An item_id is not null and is inaccessible to an end user.

An association “associates” the items on each of its two ends, either two items or one item twice. An association is inherently directional since each end is distinguishable from the other, i.e., reversing the two item_ids of an association reverses its direction. Direction in this sense is temporal; an association specifies the creation sequence (precedence) of one item relative to the other and, as a consequence, the independence/dependence of the two items. The identification of the directionality of an association is established by naming one end as the 1-end and the other as the 0-end, and arbitrarily defining the 1-end item as preceding (and independent of) a 0-end item, i.e., the directionality of an association is from the 1-end to the 0-end. In addition to the two item_ids, an association stores the following about the 1-end item with respect to the 0-end item:
1. a sign attribute storing whether the 1-end item is included or excluded from the 0-end item, or ignorance thereof, abbreviated by the parameter s; and
2. a count attribute storing how many 1-end items are associated (with the specified sign and directionality) with the 0-end item, or ignorance thereof, abbreviated by the parameter n.

Various techniques may be employed to illustrate individual elements in a structure (rather than any element). In the particular technique used herein, a stored item is illustrated as a circle with a heavy solid line (solid indicating that it is stored). Content is illustrated inside the item circle. The content of a class and a metric are written with initial capitalization; the content of an instance is surrounded by single quotation marks. Absence of content is illustrated as When useful, the item_id is illustrated to the upper left of the item circle and referred to in text by that item_id. A parameter (s, n and a) may indexed by one or more single quotes either before or after the parameter. A configuration association is illustrated by a heavy solid line with a small circle illustrated at the 0-end of the association. A non-configuration association is illustrated by a fine solid line with no indication of the end-id since the ends are determinable from the item subtype on each end. The applicable configuration association attributes are illustrated on the line.

A diagram illustrates one of the following: a non-generic example structure, a generic example structure or a pattern. A non-generic example structure is a structure that could be stored as illustrated. A generic example structure and a pattern display some combination of the following: parameters for attributes, a range of possible elements, and element supertypes (e.g., instance). Neither a pattern nor a generic structure can be stored as illustrated. A pattern is used to define the range of possible structures conveying a named type of information; a generic example structure is used to describe a range of non-generic examples and is not named.

FIGS. 1A-B are two diagrams of the I-A storage model. FIG. 1A illustrates the I-A storage model using entity/relationship (E/R) notation; FIG. 1B illustrates the I-A storage model in a simpler and more useful form. In FIG. 1A, box 101 is an entity representing any item and box 102 is an entity representing any association. Line 103 is the 0-end relation and line 104 is the 1-end relation between entities 101 and 102. Relation lines 103 and 104 are dotted where they touch item entity 101 to indicate that both the 0-end and the 1-end of association entity 102 is optional for item entity 101, and are not dotted where they touch association entity 102 to indicate that both the 0-end and the 1-end of association entity 102 must have an item. Relation lines 103 and 104 have a crow's-foot where they touch association entity 102 to indicate that there can be more than one association entity 102 having associations with the respective 0-end and 1-end. The entity attributes are illustrated inside box 101 and 102 are identified as being either a primary key (+) or a foreign key (fk) or both.

In FIG. 1B, circle 105 represents any item and line 106 represents any association. Association line 106 a simpler representation of any association because it incorporates entity 102 and relation lines 103 and 104. The end_ids (0 and 1) are shown on association line 106 along with the abbreviations for the sign and count attributes, s and n, respectively; the content attribute is shown inside item circle 105. Association line 106 is dotted on each end where it touches item 105 to indicate that both the 0-end and the 1-end of association entity 106 are optional, and has a crow's-foot where it touches item 105 to indicate that item 105 can have more than one association with a 0-end and a 1-end. This latter graphic convention and variations thereof are used in subsequent diagrams because it is simpler and does not suggest a means of implementation.

The element attributes (content, count and sign) are each independent of the other. Data, as that term is generally used, refers to what is stored by these three attributes. These three attributes are
1. Content (a) stores text, audio, video or any other such information that can be represented as a bit string. The storage model has no upper limit on length or whether it can store the absence of a bit string. Content can store a number used as an identifier but not as a quantifier.
2. Sign (s) stores one of the following about the items on the ends of an association: (1) it includes the 1-end item in the 0-end item, abbreviated by “+”; (2) it excludes the 1-end item from the 0-end item, abbreviated by “−”; or (3) there is ignorance of the above, abbreviated by “+/−”.
3. Count (n) stores one of the following about the items on the ends of an association: (1) how many 1-end items configure the 0-end item, expressed as a natural number, i.e., 1, 2, Y with no specified upper limit on length; or (2) there is ignorance about many 1-end items configure the 0-end item (abbreviated by “null” indicating a unknown condition). A count does not incorporate zero. An association with a count of zero would specify that there is no such association. The absence of an association is specified by its absence.

A technique of simplifying the storage of counts is to allow count to be stored in two forms: the first as described earlier and the second as a ratio, i.e., a numerator count and a denominator count, distinguished from the first form by a delimiter (e.g., /) between the numerator count and a denominator count. The numerator count or the denominator count, or both, can store ignorance of the respective count. Also, some implementations can store reality (discussed later) directly as an attribute rather than indirectly by an association. Count specified as a ratio is optional and is not shown in FIGS. 1A-B.

A technique of simplifying the determination of item subtype and association subtype (discussed shortly) is to store one or both of them as additional attributes of an item and an association, respectively. These attributes are optional and are not shown in FIGS. 1A-B.

The applicability of a sign and count to a given association depends on the association subtype as discussed subsequently.

### B. Axioms of Information

The axioms of information are as follows (with the term incorporating the notion described by the axiom presented in the parentheses).
1. A human creates and organizes information by: (1) creating logical constructs that each represent something (referred to here as items), and (2) creating additional logical constructs that directionally associate items (referred to here as associations).
2. The directionality of an association of two items specifies the temporal sequence of those items.
3. An item either is a classifier (i.e., it is an idea) or is classified (i.e., it is the instantiation of an idea) (respectively referred to here a concept or an instance).
4. An item either attributes (i.e., it describes) or is attributed (i.e., it is described).
   Axioms 3 and 4 introduce the following four item subtypes, in addition to concept and instance introduced in Axiom 3, that are used in subsequent axioms:
   a. an object is an item that is classified and attributed;
   b. a value is an item that is classified and attributes;
   c. a class is an item that classifies and is attributed; and
   d. a metric is an item that classifies and attributes.
5. An instance either represents something external to the information system (referred to here as a representational instance) or is the location of a bit string stored in the information system (referred to here as an internal instance).
6. An item can represent one or more included items where the included items are disjoint (i.e., do not overlap) and complete (i.e., are all specified).
7. An included item can be excluded, and we can be ignorant of whether an item is included or excluded.
8. An item represents something that is either indivisible, i.e., atomic (called a specific item), or a group of one or more included items (called a defined item), the latter being a logical construct not otherwise found in the real world (i.e., a set).
9. A representational instance either represents something that is uniquely identified so as to be distinguishable from all others (a particular instance), or represents any instance or multiples thereof among those that, while unique, are individually indistinguishable from one another (a common instance).
10. A count describes how many common instances with the same concept configure another instance of the same instance subtype (object or value), and we can be ignorant of a count (an unknown count).
11. An item can represent a duplicate of another item.
12. Two or more items other than internal instance can represent the same thing (called identical items).
13. An item other than an internal instance represents (1) something in the real world (a real item), (2) something that is not a real world item (a virtual item) or (3) something about which we ignorant as to whether it is or is not in the real world (an uncertain item); an internal instance is always in the real world. (This characteristic of an item is called its reality).
14. The concept of a specific instance is not the same concept, a subconcept nor a superconcept of any of its member instances.
15. A value applies to the whole object that it attributes, not a component thereof.
16. The values that attribute an object are independent of other objects.
17. Each value applicable to a given metric is known.
18. There are two parallel time sub-domains: one specified relative to an object whose temporal existence is known, and the other specified relative to the present moment in time.
19. Each spatial domain system is composed of three orthogonal spatial domains.
20. An object exists continuously within a single finite space-time interval whose boundaries are specified by spatial dimension and time values.

### D. Elements Subtypes

### 1. Element Subtypes Based on Classification and Attribution

Axiom 3 states that an item either is a classifier or is classified, and Axiom 4 states that an item either attributes (i.e., it describes) or is attributed (i.e., it is described). The element subtypes that arise from these axioms are illustrated in two expanded forms of the Item-Association Model are shown in FIGS. 2A-B using the graphic convention introduced in FIG. 1B. These diagrams serve to identify, define and name the element subtypes illustrated. They also identify the one-to-many constraint among the classification associations and attribution associations as well as distinguish between the 0-end and 1-end. The name of each item subtype is illustrated below the item circle and the name of each association subtype is illustrated on or adjacent to the line representing it. Content is illustrated inside the item circle as a parameter, a, with apostrophes as indexes, e.g., a′. Non-parametric content for a concept (introduced below) is written with initial capitalization. The association attributes, s and n, that apply to an association subtype are illustrated on the association line. As in FIGS. 1A-B, each component represents any element rather than an individual element.

FIG. 2A illustrates the element subtypes based on both classification and attribution. Item 201 is the item subtype: value; item 202 is the item subtype: object; item 203 is the item subtype: metric; and item 204 is the item subtype: class. Each value item 201 optionally attributes one object 202 through object attribution association 212 and is optionally classified by one metric item 203 through value classification association 213. Each object 202 is optionally attributed by one or more value item 201 through object attribution association 212 and is optionally classified by one class 204 through object classification association 224. Each metric item 203 optionally attributes one class 204 through class attribution association 234 and optionally classifies one or more value item 201 through value classification association 213. Each class 204 is optionally attributed by one or more metric item 203 through class attribution association 234 and optionally classifies one or more object 202 through object classification association 224. Each object attribution association 212 attributes its 0-end item, object 202, by its 1-end item, value item 201; each class attribution association 234 attributes its 0-end item, class 204, by its 1-end item, metric item 203; each value classification association 213 classifies its 1-end item, value item 201, by its 0-end item, metric item 203; and each object classification association 224 classifies its 1-end item, object 202, by its 0-end item, class 204. Each value configuration association 211 configures its 1-end item, value item 201, with its 0-end, another value item 201, as specified by a sign and count; each object configuration association 222 configures its 1-end item, object 202, with its 0-end, another object 202, as specified by a sign and count; each metric configuration association 233 configures its 1-end item, metric item 203, with its 0-end, another metric item 203, as specified by a sign; each class configuration association 244 configures its 1-end item, class 204, with its 0-end, another class 204, as specified by a sign.

FIG. 2B illustrates the element subtypes based classification alone. Item 251 is the item subtype: instance (which is a supertype of object and value) and; item 252 is the item subtype: concept (which is a supertype of class and metric). Each instance item 251 is optionally classified by one concept item 252 through classification association 253. Each concept item 252 optionally classifies one or more instance item 251 through classification association 253. Each classification association 253 classifies its 1-end item, instance item 251, by its 0-end item, concept item 252. (Each classification association is a supertype of object classification association and value classification association). The two attribution associations, 256 and 257 are the same associations shown in FIG. 2A as attribution association 212 and 234, respectively. Each instance configuration association 254 configures its 1-end item, instance item 251, with its 0-end, another instance item 251, as specified by a sign and count; each concept configuration association 255 configures its 1-end item, concept item 252, with its 0-end, another concept item 252, as specified by a sign.

The term “configuration” used in association subtype name encompasses all of ways that two items having the same item subtype can be associated, some terms for different forms of configuration are: groups, whole/part, generalization/specialization, duplication, composition, membership and aggregation.

The element subtype based on classification and attribution can be either determined subsequently by the attributes, directionality and orientation of the associations or can be stored when first entered into an I-A platform (since they are known at that time). The technique for subsequently determining these element subtypes is presented later as a system process called Determine Element Subtype. There are several possible techniques for storing these element subtypes as optional attributes discussed earlier. Another technique is by having the item_id be generated in a manner that identities the subject item's subtype.

By way of comparison, an object is comparable to a row in a relational database table; a metric is the name used to classify a value in a table column, i.e., nouns such as Mass and Name; a class is the name used to classify an object in each table row, i.e., nouns such as Person and Contract; and a value is an attribute or property of an object found at a row/column intersection, e.g., ‘Bob’ and 38 “kg”.

A relational database and other such platforms require that data (content sign and count) be stored consistent with a pre-specified organization, whether in a schema or the platform itself; an I-A platform has no such constraints. Elements storing data can be stored to specify any information of interest. In addition, other platforms imply some or all relationships, an I-A platform specifies all relationships where they are referred to as associations.

### 2. Instance Subtypes Based on Content

Axiom 5 states that an instance either represents something external to the information system (a representational instance) or is the location of a bit string stored in the information system (an internal instance). An instance with empty content is understood as representing a real world instance or some group of instances (e.g., a Person object or a Role object with ″ content represents a real world person or role object. An instance with non-empty content (e.g., an Email message object or a Name value) exists at an information site and is an internal instance. Since content stored in an instance is a real world instance, two internal instances with the same content are different instances. Copying an internal instance creates a new internal instance. The means for coding and decoding object content is determined by the object's class (e.g., the class: jpeg image). For a class, metric and value, non-empty content is coded and decoded consistent with one or more conventions for storing text (e.g., ASCII) and other language-based symbols specified in an I-A platform.

### III. Structures

### A. Non-Configuration Structures

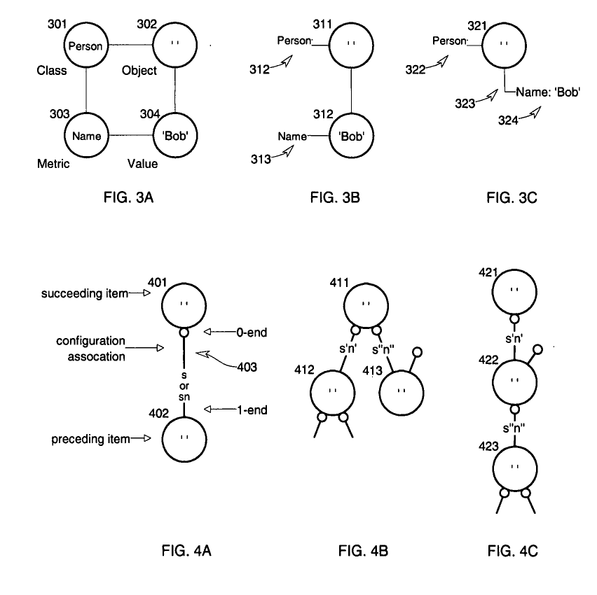

A non-configuration structure has each of the four item subtypes and the four non-configuration associations. FIGS. 3A-C show the same non-generic example non-configuration structure using three different illustrations conventions used here. FIG. 3A applies the convention described earlier. Items 301, 302, 303 and 304 are items whose subtypes are: class, object, metric and value, respectively. Class 301 has content: Person; metric item 303 has content: Name; value item 304 has content: ‘Bob’; and object 302 has no content, denoted as ″, because it represents a real world object. The non-configuration association between class 301 and object 302 is an object classification association classifying the object as Person. The non-configuration association between class 301 and metric item 303 is a class attribution association attributing the class: Person with the metric: Name. The non-configuration association between object 302 and value item 304 is an object attribution association attributing the object with the Name value: ‘Bob’. The non-configuration association between metric item 303 and value item 304 is a value classification association classifying the value ‘Bob’ as a Name. This structure conveys the following information: Name applies to Person and there is a Person object with the Name value: ‘Bob’. This would be stored in a relational database in a Person table having a Name column where a row represents the object and the intersection of the subject row and Name column contains ‘Bob’.

FIGS. 3B and 3C are the same example using “call-outs”, orientation and text formatting to illustrate the same information. The graphically omitted elements can be readily determined from those illustrated. In FIG. 3B, object 311 is the same as 302 and value 312 is the same as 304. Text 312 is class 301 but without the item circle; text 313 is metric item 303 without the item circle. In FIG. 3C, object 321 is object 311 and 302; value item 322 is the same as value item 312 and 301; line 323 is a combination of the object attribution association and the value classification shown in FIG. 3A between item 303 and 304 and between items 304 and 302. Text 324 illustrates the combination of the content of the metric and value items.

B. Configuration Structures

A configuration structure configures multiple items of the same item subtype and conveys information about the one or more (1-end) items of a given subtype (class, object, metric or value) configuring another such item. In order to convey information, the included items in the structure must be disjoint and complete as described by Axiom 6. This is presumed to be the case absence any evidence to the contrary; where there is evidence to the contrary, the structure is invalid.

An item with both one or more 0-end configuration associations and one or more 1-end configuration associations is a stem item; an item with only one or more 0-end configuration associations is a root item; an item with only one or more 1-end configuration associations is a leaf item; and an item with no configuration associations is a seed item.

Axiom 7 states that an included item can be excluded and that we can be ignorant of whether an item is included or excluded. This is taken to be a constraint, i.e., something cannot be excluded that is not also included.

FIGS. 4A-C illustrate three generic example structures using the illustration convention introduced above. FIG. 4A is a generic structure where item 402 configures item 401 through configuration association 403 having the parametric sign attribute (s) and, for instances, the parametric count attribute (n). Consistent with Axiom 2, the 1-end item is identified as temporally preceding the 0-end. The generic structures in FIGS. 4B and 4C show the convention for illustrating a portion of a configuration structure where some items are not illustrated. With this convention, FIG. 4B specifies the following: item 411 is configured by item 412 and 413, and configures no items (it is a root item); item 412 is configured by two un-illustrated items and configures item 411 (it is a stem item); and item 413 is configured by no items, and configures item 411 and one un-illustrated item (it is a leaf item).

FIG. 4C specifies the following: item 421 is configured by item 422 and configures no items; item 422 is configured by item 423, and configures item 421 and one un-illustrated item; and item 423 is configured by two un-illustrated items and configures item 422.

### C. Element Subtypes

### 1. Instance Subtypes Based on Atomicity

Axiom 8 states that an item is either a specific item (i.e., it represents something that is indivisible, i.e., atomic) or a defined item (i.e., a group of one or more included items).

A concept is a defined concept if it has subconcepts. For example, the class: Tree has the class: Oak tree, among others, as its subclasses. A defined concept is nothing more than the grouping of included concepts, hence the use of the term: defined.

A defined instance is a group of one or more included instances, e.g., a People object representing the group of people who were (had the role of) president of the United States. A specific instance may be regarded as configured by parts, e.g., an Automobile object configured by an Engine object and a Body object. An instance configured by parts is called a product instance and each of its configuring instances is called a member instance. A defined instance and a product instance differ as follows:

Everything that can be known about a defined instance is determined from its defining instances, i.e., a defined instance is nothing more than its defining instances.

Only some of what is known about a product instance can be determined from its member instances. A product instance is something new, created by member instances that are able to interact in some manner. A product instance cannot be understood only by those member instances: This is generally expressed as “the whole (i.e., product) is more than the sum of its parts (i.e., members)”

These differences do not provide a basis for distinguishing between these two types of instances where stored in an I-A platform; the technique for distinguishing between stored instances is discussed later.

### 2. Instance Subtypes Based on Item Identification

Axiom 9 states that a representational instance is either a particular instance (representing something that is uniquely identified so as to be distinguishable from all others) or a common instance (representing any instance or multiples thereof among those that, while unique, are individually indistinguishable from one another). A particular object is uniquely identified directly through its values or indirectly through its configuration among other objects, or some combination thereof; a common object is not. A particular value is an identifier (e.g., a name or an id number); a common value is not. (All concepts and internal instances are regarded as particular). The distinction between particular and common instance is recognized in the use of articles and noun forms in the English language, i.e., a particular instance is identified by the article “the” preceding a noun; a single common instance is identified by the articles: a” or “an”, and by plural nouns indicating multiples of the common instance.

Axiom 10 states that a count describes how many common instances with the same concept configure another instance of the same instance subtype (object or value), and that we can be ignorant of a count. While it may be possible to store each common instance that configures another instance, there is no need to do so. In addition, that technique does not provide a means of specifying ignorance of the count. The I-A storage model incorporates count as an attribute of an instance configuration association. With this technique, only one configuring common instance need be stored and its configuration association can specify either the count or ignorance thereof. The count attribute is thus a natural number other than zero. Since sign and count arise from different axioms, sign and count are independent, and are treated as separate attributes.

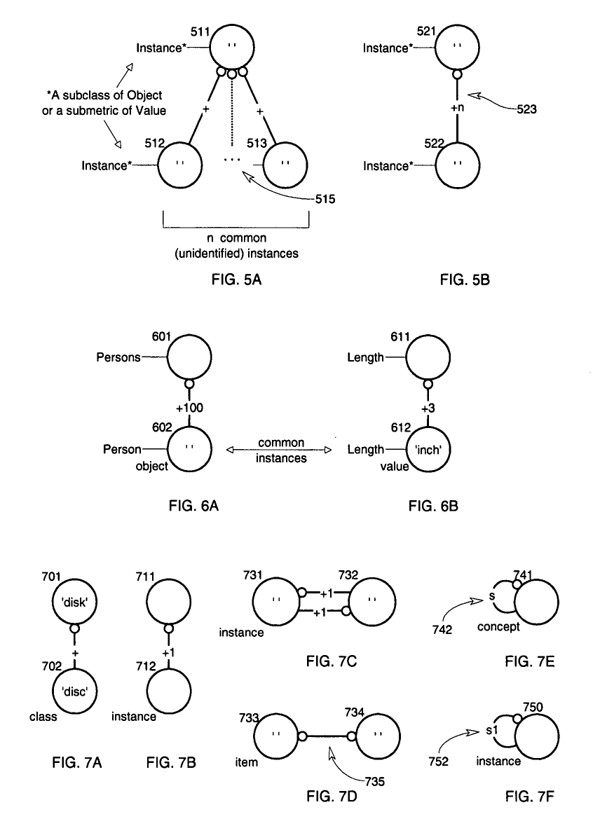

The two techniques for storing a count, i.e., storing each common instance that configures another instance and storing a count as an attribute of an instance configuration association, are shown in FIGS. 5A-B. The generic example instance structure in FIG. 5A specifies that instance 512 and instance 513 are among n different individually-stored common (unidentified) configuring instances that configure instance 511. The dotted association line and the ellipses 515 indicate that there are zero or more additional items and associations. Instance 511 represents those n different common instances. The structure in FIG. 5B stores n as the attribute of instance configuration association 523 with one configuring common instance, instance 522, representing any instance having a given concept and values. Instance configuration association 523 specifies that common instance 522 is included in instance 521 n times, i.e., there are n different common objects that are each included in instance 521 so that instance 521 represents n different common instances.

FIGS. 6A-B illustrate two non-generic example instance configuration structures with configuring common instances. In FIG. 6A, common object 601 is classified by the class: Person and represents any person. The object configuration association from 602 to 601 includes object 601 in object 602 100 times so that object 601 represents a group of 100 Persons. In FIG. 6B, common value 612 classified by the metric: Length and having content ‘inch’, represents any length in ‘inches’. The value configuration association from value 612 to 611 includes common value 612 in value 611 3 times so that value 611 represents a length of ‘inches’. (A value with ‘inch’ as content as defined in a value domain discussed later).

### 3. Duplicate and Identical Items

Axiom 11 states that an item can represent a duplicate of another item and Axiom 12 states that two or more items other than internal instances can represent the same thing.

The technique for specifying an item as a duplicate of another item is for the duplicated item to be the only item included in the duplicate item and to be included only once. A duplicate concept represents the same concept but with different content; a duplicate instance represents the same instance with the duplicated concept having either the same concept as or a superconcept of the duplicated instance. Although a duplicate item and the item it duplicates represent the same item, the former is subsequent to the latter.

FIG. 7A illustrates a non-generic example structure that demonstrates the use of this technique. Class 702 with content: ‘disc’ is the only class defining class 701 which as content: ‘disk’ through a + class configuration association, thereby specifying ‘disk’ as a duplicate of ‘disc’, in this case a synonym absent other context. This structure specifies that ‘disk’ is the same class as ‘disc’, but that the former term is subsequent to the latter. FIG. 7B illustrates a non-generic example instance structure where instance 712 is the only instance defining instance 711 through a +1 instance configuration association, thereby specifying instance 711 as a (subsequent) duplicate of instance 712.

The technique for specifying two items as being identical, i.e., two different representations of the same item, is by two configuration associations that each specify the items as being a duplicate of the other, i.e., through two configuration association with opposite directionality each including the other item once. Since the two items cannot both be subsequent to the other, they must be simultaneous, thereby conveying the notion of identity. FIGS. 7C and 7D demonstrate the use of this technique. In FIG. 7C, instance 731 is a duplicate of instance 732 and vice versa, thereby specifying that instance 731 and instance 732 are identical.

FIG. 7D shows a simpler graphic convention for illustrating two items as identical. Line 735 with a single line with a small o on each end represents the two associations that specify item 733 and item 734 are identical. That line is called an identity association and graphically represents the two associations shown in FIG. 7C. This simpler graphic convention used in subsequent diagrams.

Two or more items specified as identical form a network called an identity network. An item in an identity network is either identical to other items by its stored identity associations with them or implied as identical to other items indirectly through other items in the identity network. An identity network is allowed to have redundant identity associations, i.e., an item can have a stored identity association even though its identity could be implied. The choice to store rather than imply an identity association conveys preference information about the items in a network.

The distinction between duplication and identity described above is analogous to the following distinction in mathematics where x, y, a and b are algebraic variables:

If y=f(x) and f(x) is x, then y=x, i.e., y is dependent on and a duplicate of x;

If y=a+b and x=a+b, then y==x, i.e., x and y are identical.

The contents of two identical concepts are understood as synonyms with context, e.g., different content identifying the same concept in the context of different languages. Since the content of an internal object is a real world object, two internal objects cannot be identical, even if they have the same concept. This is enforced by the entry and validation processes that find and delete an identity association specifying two objects as identical.

### 4. Item Reality

Axiom 13 states that an item other than an internal instance that represents a real item (something in the real world), a virtual item (something that is not a real world item) or an uncertain item (something about which we ignorant as to whether it is or is not in the real world). This characteristic is called an item's reality. Examples of virtual objects are a unicorn and a work task scheduled in the future. The technique for specifying the reality of these items is by a single configuration association that having a count of where the item on each of the two ends is the subject item. An item has one of the following three realities determined by the sign attribute:
1. an item is real if s is +, i.e., the item includes itself once consistent with what is commonly understood as real;
2. an item is virtual if s is −, i.e., the item excludes itself once and is, therefore, virtual, abbreviated as ?; and
3. an item is uncertain if s is +/−, i.e., the item either includes or excludes itself once, meaning that there is ignorance regarding whether it is real or virtual, abbreviated as ?.

The generic example configuration structures in FIGS. 7E and 7F demonstrate the use of this technique. In FIG. 7E, concept 741 has concept configuration association 742 with the same concept on each end and a parametric sign. In the generic instance structure shown in FIG. 7F, instance 750 has instance configuration association 752 with the same instance on each end, a count of and a parametric sign. An item without such a stored configuration association is implied as being real. Reality is treated here as an attribute of an item having the parameter r and may or may not be stored as an attribute of an item. An internal instance is always real.

### D. Concept Structures

### 1. Concept Hierarchies

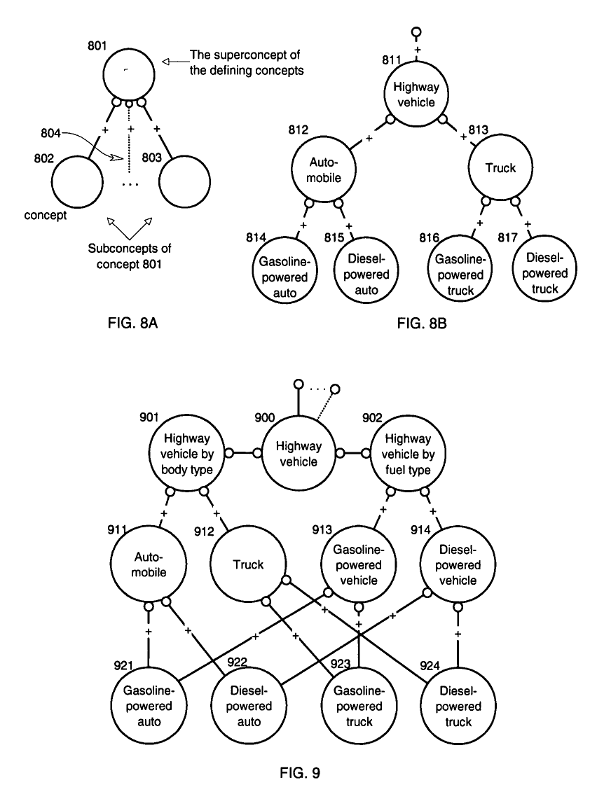

A concept hierarchy specifies the concepts that define another concept of the same subtype (i.e., class or metric). A superconcept is a generalization of two or more concepts. The concepts that define a superconcept are each a subconcept (or specialization of the concept they define. The technique for specifying the subconcepts that define a concept is through configuration association. The diagrams in FIGS. 8A-B demonstrate the use of this technique. FIG. 8A is a pattern called the concept hierarchy pattern. This pattern describes how concept 802 and concept 803 along with zero or more other concepts define concept 801 each through its own + concept configuration association. Concept 801 is a superconcept of each of its defining concepts; the defining concepts 802 and 802 among zero or more others are each a subconcept of concept 801. FIG. 8B illustrates a non-generic example class hierarchy structure where the class hierarchy pattern is repeated three times. Class 811 is a superclass with content: Highway vehicle that has subclasses 812 with content: Automobile and subclass 813 with content: Truck. Classes 814, 815, 816 and 817 are similarly subclasses of the two classes they define.

In order to be disjoint and complete (Axiom 6), a concept cannot be a subconcept of itself, either directly or thorough other concepts and a concept can be a superconcept of another concept only once. These constraints are enforced by the entry and validation processes within an I-A platform. Any concept hierarchy must be consistent with Axiom 14 which states that a concept of a specific instance cannot be the same concept, a subconcept or a superconcept of the concept of any of its member instances. This constraint is also enforced by the entry and validation processes.

### 2. Concept Structure with Identity Network

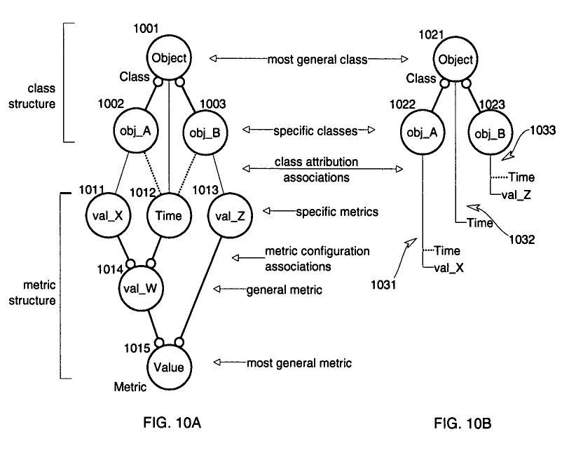

In a given I-A Platform, all concepts of interest are specified by one class structure and one metric structure. A concept structure can specify superconcepts and subconcepts as described above and synonyms without context as demonstrated in previous examples. Using identical concepts, a concept structure can also specify alternative hierarchies and the context for each hierarchy, as well as context for synonyms. The non-generic example class structure in FIG. 9 illustrates a portion of a class structure with two different class hierarchies for the same class: Highway vehicle, one of which was presented in FIG. 8B. Classes 900, 911, 912, 921, 922, 923 and 924 are the same as the following classes in FIG. 8B: 811, 812, 813, 814, 815, 816 and 817, respectively. Class 901 having content: Highway vehicle by body type, and class 902 having content: Highway vehicle by fuel type are each identical to class 900 in an identity network (composed of classes 901, 900 and 902). Classes 901 and 902 specify the context for the hierarchies of which they are each a root.

Given Axioms 8 and 12: identical defined items, representing the same item, must be defined by the same specific items. Class 901 and 902 are each defined by classes 921, 922, 923 and 924 through stored concept definition associations and intermediate classes 911, 912, 913 and 914. The two intermediate classes 911 and 912 are defined by classes 921, 922, 923 and 924 and the other two intermediate classes, 913 and 914 are also defined by classes 921, 922, 923 and 924. The two intermediate classes 911 and 912 are orthogonal to the other two intermediate classes, 913 and 914. Class 900 need not stored concept definition associations with those four classes since they would be redundant and are, therefore, implied.

The plural form of a concept name can be specified by a concept with the plural text that is the concept of a common instance that is defined by +null of the instance having the concept whose text is in singular form.

### 3. Combined Class and Metric Structure

Since a general class has only the characteristics commonly found in each of its defining specific classes, a general class has only the metrics commonly found in each of the specific classes defining it. Thus storing a class attribution association from a metric to each subclass of the most general class to which it applies is redundant and can be implied. The technique of eliminating this redundancy is to have each undefined metric attribute just one class and having the I-A platform system apply the metrics of a superclass to each of its subclasses. (This technique is commonly referred to as inheritance). Having each undefined metric attribute just one class is a constraint that is enforced by the entry and validation processes. In addition, a defined metric cannot classify a value since the metric of a value is always known. This is also enforced by the entry and validation processes.

Axiom 15 states that a value apples to the whole object that it attributes, not a component thereof. This axiom is implemented by specifying each class attribution association so that a metric only attributes the class whose objects the metric applies in whole. For example, color is an attribute of the iris of an eye, not the eye as a whole. Axiom 16 states that the values that attribute an object are independent of other objects. For example, a SSN is an attribute that is an identifier of an account; it is not a value for a Person object. This axiom is implemented by specifying each class attribution association so that a metric only attributes the class whose objects which that metric applies independently of other objects. Neither of these axioms can be enforced within an I-A platform.

FIGS. 10A-B illustrates a simple generic example structure of a combined class and metric structure using two illustration conventions. In FIG. 10A, Class 1001 is the most general (root) class in the class hierarchy having content ‘object’ and classes 1002 and 1003 are specific classes defining root class 1001. Metric 1015 having content: ‘value’ is the most general (root) metric in the metric hierarchy, metrics 1011, 1012 and 1013 are specific metrics either directly or indirectly defining root metric 1015. Metric 1014 is a general metric directly defining root metric 1015. The three specific (leaf) metrics, 1011, 1012 and 1013, each have one class attribution association with a class. The class attribution associations from metric 1011 to class 1002, from metric 1012 to class 1001 and from metric 1013 to class 1003 are stored. The class attribution associations from metric 1012 to class 1002, and from metric 1012 to class 1003 are not stored, rather they are implied (i.e., class 1002 inherits metric 1012, Time, from class 1001) and are illustrated by dotted attribution association lines.

In FIG. 10B, classes 1021, 1022 and 1033 are the same as classes 1001, 1002 and 1003, respectively. Association lines 1031, 1032 and 1033 are the respective class attribution associations described in the above paragraph. The text at the ends of association lines 1031, 1032 and 1033 are the content of specific metrics 1011, 1012 and 1013 without the circle. The text: Time after the dotted line at the ends of association lines 1031 and 1033 is the content of implied (inherited) metric 1012.

### E. Concept Comparison and Resulting Elements Subtypes

### 1. Concept Comparison

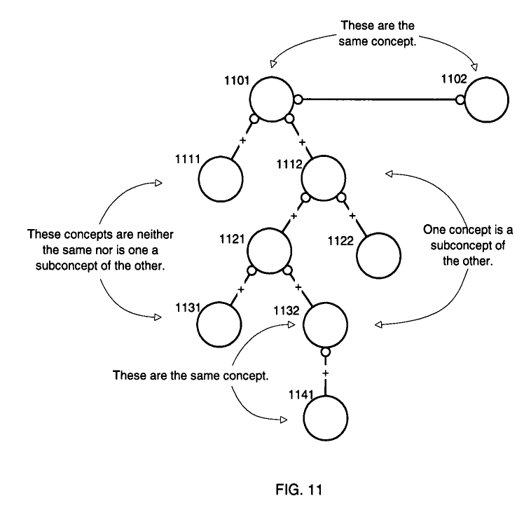

Any two classes or any two metrics within their respective concept structures can be compared to determine the nature of their configuration. FIG. 11 is a simple generic example concept structure that describes how various pairs of concepts compare to one another. Concept comparison is a technique implemented within an I-A platform as a process. The following lists the possible results (output) of the concept comparison process given the inputs: class_1 and class_0 are:
sub/super-concept if concept_1 defines (is a subconcept of) concept_0;
super/sub-concept if concept_0 defines (is a subconcept of) concept_1;
same concept if: (1) concept_and concept_0 are identical (2) concept_1 or concept_0 is a duplicate of the other, (3) some combination of each of (1) and (2), or (3) the comparison is to itself;
different-concepts if none of the above apply.

Examples of comparison results for the concept pairs shown in FIG. 11 are listed in Table 1.

TABLE 1
Example Concept Comparison Results

| Comparison result | concept_1 | concept_0 |
|---|---|---|
| super/sub-concept | 1112 | 1132 |
| sub/super-concept | 1132 | 1112 |
| same concept | 1101 | 1102 |
| | 1132 | 1141 |
| | 1121 | 1121 |
| | 1122 | 1122 |
| different-concept | 1131 | 1111 |
| | 1111 | 1131 |

### 2. Configuration Association Subtypes Based on Concept Comparison

Since an instance configuration association has an instance on each end and each instance has a concept, comparing those concepts conveys information about that association. A concept configuration association is also described by comparing the concept on each end. The resulting configuration association subtypes are tabulated in Table 2. The applicable iconic abbreviation is illustrated on the line representing a configuration association surrounding the sign and count attributes as shown in subsequent diagrams.

TABLE 2
Configuration Association Subtypes Based on Concept Comparison

| concept | | | |
|---|---|---|---|
| comparison | iconic | configuration association subtype | |
| result | abbreviation | for instances | for concepts |
| same- | >< | instance summation | concept summation |
| concept | | association | association |
| super/sub- | >> | instance | concept generalization |
| concept | | generalization | association |
| | | association | |
| sub/super- | << | instance | concept specialization |
| concept | | specialization | association |
| | | association | |
| Different- | <> | production | NA |
| concept | | association | |

### 3. Configuration Patterns Based on Concept Comparison

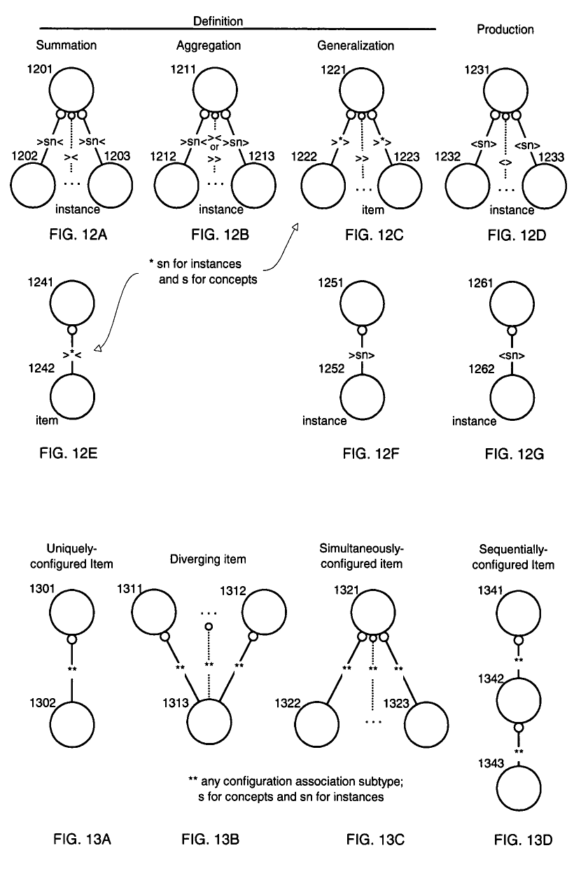

The above configuration association subtypes based on concept comparison are useful in typing structures and further subtyping items. FIGS. 12A-G illustrate seven patterns describing each possible way that either one, or two or more items can configure another item using the above association types. Each configuration association subtype is identified by its iconic abbreviation surrounding the sign and count. The name of each pattern (i.e., information type) is shown above it. FIG. 12A illustrates a simultaneous instance summation pattern where instance 1201 is configured by instances 1202 and 1203 among others through instance summation associations. FIG. 12B illustrates a simultaneous instance aggregation pattern where instance 1211 is configured by instances 1212 and 1213 among others through a combination of instance summation associations and instance generalization associations. FIG. 12C illustrates a simultaneous item generalization pattern where item 1221 is configured by items 1222 and 1223 among others through either item generalization associations. FIG. 12D illustrates a simultaneous instance production pattern where instance 1231 is configured by instances 1232 and 1233 among others through production associations. The term simultaneous is used to indicate that the configuring items simultaneously configure the configured item. FIG. 12E illustrates a unique item summation pattern where item 1241 is configured by item 1242 through a summation association. FIG. 12F illustrates a unique instance generalization pattern where instance 1251 is configured by instance 1252 through an instance generalization association. FIG. 12G illustrates a unique instance production pattern where instance 1261 is configured by instance 1262 through a production association.

### 4. Instance Subtypes Based on Configuration Patterns

Axiom 14 states that the concept of a specific instance is not the same concept, a subconcept nor a superconcept of any of its member instances. This axiom provides the means of distinguishing between defined and product instances because a product instance is configured only through production associations and a defined instances is configured only through definition associations. The configured item subtypes based on the item's 0-end configuration association(s) are found in the patterns shown in FIGS. 12A-G and are as follows. Instance 1201 and item 1241 are sum items; instance 1211 is an aggregate instance; item 1221 and instance 1251 are general items; and instances 1231 and 1261 are product instances.

The configuring item subtypes based on the item's 1-end configuration association are also subtyped based on the patterns shown in FIGS. 12A-G as follows. Instances 1202 and 1203 among others, as well as item 1242, are portion items; instance 1222 and 1223 among others, as well as 1252, are special items; and instances 1232 and 1233 among others, as well as 1262, are member instances. In addition, an undefined instance is an instance that is either an unconfigured instance or a product instance.

FIGS. 13A-D illustrate generic example structures that identify four additional configured and configuring item subtypes based on the item's 0-end or I-end configuration association(s) that are used later. These configured item subtypes are not based on concept comparison. FIG. 13A illustrates a generic example structure where item 1301 is a uniquely-configured item, i.e., it is configured by item 1302 alone (FIG. 13A); FIG. 13B illustrates a generic example structure where item 1313 is a diverging item, i.e., it configures two other items, items 1311 and 1312 among others; FIG. 13C illustrates a generic example structure where item 1321 is a simultaneously-configured item, i.e., it is configured by items 1322 and 1323 among others simultaneously; FIG. 13D illustrates a generic example structure where item 1341 is sequentially-configured, i.e., item 1343 configures item 1342 prior to item 1342 configuring item 1341.

### IV. Expressions

### A. Expression Types

The information conveyed by an element in the context of a structure is readily and usefully described in the form of a text string called an expression. An expression resembles an arithmetic/algebraic expression but is more comprehensive, robust and consistent. An expression identifies each item, its attributes, certain element subtypes, whether it is stored or implied, instance concepts, directionality of associations, the reality of items and the configuration of the items.

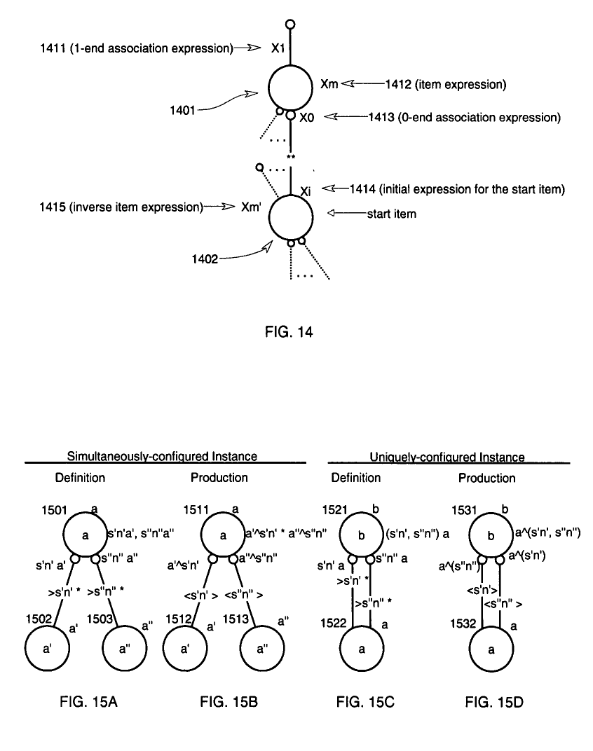

An expression is generated by a process that traverses a configuration structure, gathers the characteristics of each element traversed and generates the appropriate expression. An expression is generated at different points in a structure, each point described by an expression type. FIG. 14 is a generic example configuration structure showing those points and the expression types. The expression types (along with its abbreviation) are as follows:
initial expression (Xi), expression 1414: an expression generated for a item prior to traversing any other elements that expresses the item's content and reality, e.g., item 1402 is a start item in this example structure;
0-end association expression (X0), expression 1413: an expression generated after traversing a configuration association along a path with the same directionality, e.g., from item 1402 to 1401;
item expression (Xm), expression 1412: an expression generated for an item other than a start item from the combination of its 0-end association expressions and the item's reality, e.g., item 1401;
1-end association expression (X1), expression 1411: an expression generated after traversing a configuration association by a path with the opposite directionality, e.g., the configuration association whose or 1-end item is item 1401; and
inverse item expression (Xm′), expression 1415: an expression generated for an item other than a start item from the 1-end association expressions

The format of an expression is dependent on the expression type and the type of structure that generates it. Each expression type is discussed below.

### 1. Initial Expression

An initial expression (Xi), an expression generated for a start item from the item's content and reality, is independent of its associations and, therefore, applies to any item subtype. The initial expression formats, illustrated using parameters, are as follows:

| | |
|---|---|
| for concepts: | r Ψα or ra |
| for instances: | r Ψα β or ra β |

where α is the item_id, Ψα is the content of item α, and β is the concept of the instance α. The parameters a and r were defined earlier. The concept (β) is often omitted for the sake of brevity but can be determined from an example structure or pattern. A self-defining association specifying an item's reality may be omitted for simplicity with that reality identified by the item's initial expression.
2. 0-end Association Expression

A 0-end association expression (X0) is generated after traversing a configuration association along a path with the same directionality. The parametric 0-end association expressions for item 1401 in terms of item 1402 are as follows:

| | |
|---|---|
| concept definition association: | s rΨα or s ra |
| concept definition association: | sn rΨα β or sn ra β |
| production association: | r(Ψα)\hat{ }sn β or r(a)\hat{ }sn β |

where sn is an exponent and r, a, Ψα and β are for the start item (α). The two association attributes (sn) are grouped separately from the instance attributes r Ψα or ra, and separated by either a space or a carat (i.e., ̂). The carat is used to both delimit and identify the association as a production association.

Examples of 0-end association expression are tabulated in Table 3 for item types based on classification and attribution, and those based on reality.

TABLE 3
Examples of 0-end Association Expression

| item subtypes taxonomy | | | | | |
|---|---|---|---|---|---|
| based on classification and | | | | | |
| attribution with parametric | | | item subtype based on reality | | |
| expression formats | | | real item | virtual item | uncertain item |
| Concept r Ψα | | class | ‘Cat’ | 0 ‘Cat’ | [no examples] |
| | | metric | ‘Height’ | [no | [no examples] |
| | | | | examples] | |
| instance | non- | object | 3 “‘Cats’ | 0 “‘Cats’ | ? “‘Cats’ |
| | products | value | −3 ‘feet’ | (−3) 0 ‘feet’ | −3 ? ‘feet’ |
| | n r Ψα β | | ‘Height’ | ‘Height’ | ‘Height’ |
| | Product | object | “\hat{ }1 ‘Cat’ | 0 “\hat{ }1‘Cat’ | ? “\hat{ }1’Cat’ |
| | (r Ψα)\hat{ } | value | ‘feet’ \hat{ }2 | 0 ‘feet’ \hat{ }2 | ? ‘feet’ \hat{ }2 |
| | sn β | | ‘Area’ | ‘Area’ | ‘Area’ |

### 3. Item Expression

An item expression (Xm) is generated for an item other than the start item from the combination of its 0-end association expressions and its reality. Item expressions are discussed below, first for simultaneously-configured items and uniquely-configured items, then for sequentially-configured items, and finally for uncertain items. While the discussion here is for instances, it also applies to concepts for the special case where there its only one definition association between each instance.

Item expressions can be applied to simultaneously-configured items and uniquely-configured items. An item expression for a simultaneously-configured item combines multiple 0-end association expressions, each of which is called a term. The item expression illustrates each term with delimiters that identify the association subtype involved as either a definition association or a production association. The delimiting characters, the applicable element subtypes and a parametric expression are tabulated in Table 4. These delimiters are each understood as the equivalent of the conjunction “and”.

TABLE 4
Characters Used to Delimit Terms in an Item Expression

| | | Simultaneously- | |
|---|---|---|---|
| Delimiting | Association | configured instance | Parametric |
| character | subtype | subtype | expression |
| * | production | product instances | ΨA′ * Y * ΨA\ |
| | association | | |
| , | definition | defined item | ΨA′, Y, ΨA\ |
| | association | | |

The generic example structures in FIGS. 15A-D illustrate simultaneously-configured instances and uniquely-configured instances for both defined and product real instances with parametric expressions for the following expression types: initial expressions, 0-end association expressions and item expressions. Using the delimiting characters shown in Table 4, FIG. 15A illustrates a generic simultaneous definition structure with an item expression for simultaneously-defined instance 1501 in terms of instances 1502 and 1503; FIG. 15B illustrates a generic simultaneous production structure with an item expression for simultaneously-produced instance 1511 in terms of instances 1512 and 1513; FIG. 15C illustrates a generic unique definition structure with item expression for uniquely-defined instance 1521 in terms of instance 1522; and FIG. 15D illustrates a generic unique production structure with the item expression for uniquely-produced instance 1531 in terms of instance 1532. The respective item expressions are as follows: s′n′a′, s″n″a′; a′̂s′n′*a″̂s″n″; (s′n′, s″n″) a; and â(s′n′, s″n″). Any non-null content of a configured item can be seen as the name given to its configuring elements. For example, the content of item 1501, shown parametrically as a, is the name given to item expression illustrated as sn′a′, s″n″a″.

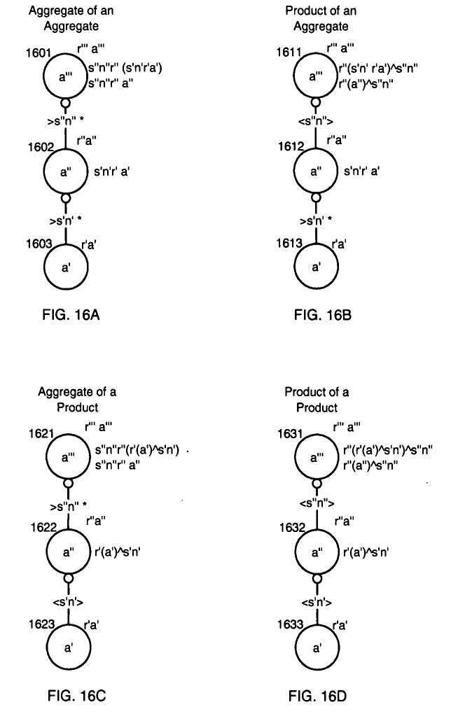

Expressions can also be applied to sequentially-configured items. The generic example structures in FIGS. 16A-D illustrate sequentially-configured instances for four combinations of definition and production associations with parametric expressions for the following expression types: initial expressions and item expressions. Each instance has any reality, indicated by the parameter r. The means of illustrating the sequence of combined terms in an expression is with nested parentheses. FIGS. 16A-D illustrate the sequential generation item expressions. In FIG. 16A, instance 1602 has an item expression in terms of instance 1603 reflecting the definition association and instance 1601 has two item expressions: one in terms of instance 1603 and the other in terms of instance 1602, each reflecting the definition association with instance 1601. In FIG. 16B, instance 1612 has an item expression in terms of instance 1613 reflecting the definition association and instance 1611 has two item expressions: one in terms of instance 1613 and the other in terms of instance 1612, each reflecting the production association with instance 1611. In FIG. 16C, instance 1622 has an item expression in terms of instance 1623 reflecting the production association and instance 1621 has two item expressions: one in terms of instance 1623 and the other in terms of instance 1622, each reflecting the definition association with instance 1621. In FIG. 16D, instance 1632 has an item expression in terms of instance 1633 reflecting the production association and instance 1631 has two item expressions: one in terms of instance 1633 and the other in terms of instance 1632, each reflecting the production association with instance 1631. The respective item expressions for configured instances 1601, 1611, 1621 and 1631 (in FIGS. 16A-D respectively) in terms of each of their sequentially-configuring instances using nested parentheses are as follows:

| | | |
|---|---|---|
| s″n″r″ (s′n′r′a′) | and | s″n″r″ a″ |
| r″(s′n′ r′a′)\hat{ }s″n″ | and | r″(a″)\hat{ }s″n″ |
| s″n″r″(r′(a′)\hat{ }s′n′) | and | s″n″r″ a″ |
| r″(r′(a′)\hat{ }s′n′)\hat{ }s″n″ | and | r″(a″)\hat{ }s″n″ |

Instead of nested parentheses, a solid dot (•) can be used to identify the sequence of the combined terms for an aggregate of an aggregate: s″n″r″(s′n′r′a′)<=>s″n″r″•s′n′r′a′

where <=> identifies the two expressions as different formats that describe the same configuration of elements using the same attributes.

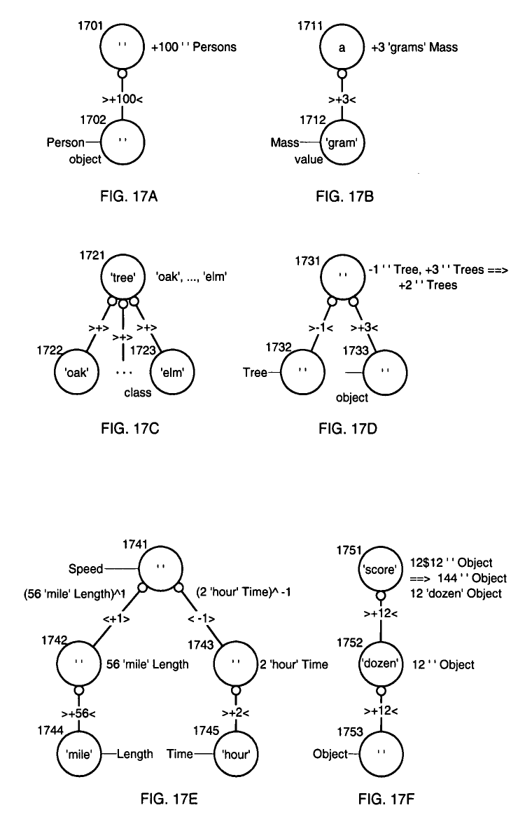

FIGS. 17A-F illustrate non-generic example structures with item expressions for concepts and for instances where the expression includes the concepts. A unit of measure is the content of a value defined by other values in a value domain. The character string “==>” is used to identify that the following expression is a simplification of the preceding expression. In FIG. 17A, the item expression for sum object 1701 (+100″ Persons) is in terms of object 1702 which has the class: Person. In FIG. 17B, the item expression for sum value 1711 (+3 ‘grams’ Mass) is in terms of value 1702 which has the metric: Mass and content: ‘grams’, a unit of measure. In FIG. 17C, the item expression for general class 1721 (‘oak’, . . . , ‘elm’) is in terms of classes 1722, 1723, among others that are not displayed, that have content: ‘oak’ and ‘elm’, respectively. In FIG. 17D, the item expression for sum object 1731 (−1″ Tree, +3″ Trees) is in terms of objects 1732 and 1733 which each have the class: Tree. The simplified form of that item expression is +2″. In FIG. 17E, the item expression for sum value 1742 (56 ‘mile’ Length) is in terms of value 1744 having metric: Length and content: ‘mile’, a unit of measure. The item expression for sum value 1743 (2 ‘hour’ Time) is in terms of value 1745 having metric: Time and content: ‘hour’, a unit of measure. The item expression for product value 1741 ((56 ‘mile’ Length)̂1)* ((2 ‘hour’ Time)̂−1) is in terms of values 1742 and 1743 generated from the 0-end association expressions. The progressive simplified forms of that expression are as follows.

==>(56 ‘mile’ Length)*((2)̂1(‘hour’)̂−1 Timê1)

==>56/2 ‘mile’/‘hour’ Length/Time==>28 ‘mile’/‘hour’ Speed

In FIG. 17F, the item expression for sum object 1752 (12″ Object) is in terms of value 1744 having class: Object. The item expression for sum object 1751 (12•12″ Object) is in terms of object 1753 and (12 ‘dozen’) in terms of object 1752. The simplified form of the former item expression is (144″ Object).

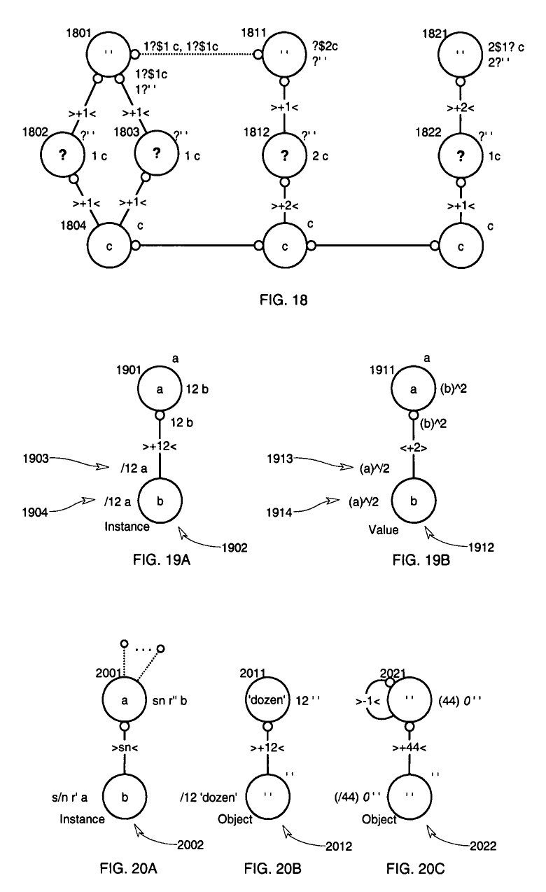

Furthermore, item expression can be applied to uncertain items. The generic example structures in FIG. 18 illustrate two different ways of specifying an instance as uncertain. Each intermediate instances 1802, 1803, 1812 and 1822 are each specified as uncertain (reality is ?) illustrated with a “?” inside its item circle as well as in their expressions. Instance 1801 and 1811 are identical because they specify the same inclusion of instance 1804 (as indicated by the implied identity association); instance 1811 and 1821 are not identical because they specify different inclusions of instance 1804, i.e., intermediate instance 1812 represents two uncertain instances while intermediate instance 1822 represents one. Instance 1811 has the item expression: ?•2c, understood as the possibilities: [0 or 1 or 2]c; instance 1821 has the item expression: 2•1? c, understood as the possibilities: [0 or 2]c.

4. 1-end Association Expression and Inverse Item Expression

The above described the generation of expressions by traversing in the same direction as the association. A 1-end association expression (X1) and an inverse item expression (Xm′) are generated by traversing a path in the opposite direction of the association. FIGS. 19A-B illustrate generic examples of a unique summation instance structure and a unique product value structure. The diagrams illustrate the initial expressions, 0-end association expressions and item expressions for sum instance 1901 and for product value 1911. As illustrated in FIG. 19A, instance 1901 is a defined by +12 of common portion instance 1902, i.e., the former is the multiple of +12 of the latter, and is expressed as such by both its 0-end association expression and its item expression. Value 1911 is produced by +2 of common value 1912, i.e., the former is the power of +2 of the latter, and is expressed as such by both its 0-end association expression and its item expression (FIG. 19B). The two configuring instances can be understood in terms of its configured instance as follows. Common portion instance 1902 is the reciprocal of +12 (i.e., /12 of its sum instance) as shown as 1-end association expression 1903 and inverse item expression 1904. Common member value 1912 is the reciprocal of the power of +2 (i.e., ̂/2 power or the square root of its product value) as shown as 1-end association expression 1913 and inverse item expression 1914. A forward slash (/) before a count, /n, is the means of indicating that the expression was generated in a direction opposite to that of the association as well as indicating that the count is a reciprocal, e.g., the reciprocal of n. (Only the count is reciprocated; sign, reality and content are not similarly affected.)

The example uniquely-configured summation structures in FIGS. 20A-C illustrate inverse item expressions for three portion instances; the 1-end association expressions are the same and are omitted. The respective inverse expressions for the instance 2002, object 2012 and 2022 in terms of instance 2001, object 2011 and object 2021 (FIGS. 20A-C respectively) are: s/n r′a; /12 ‘dozen’; (/44) 0″. If the count in an inverse item expression (or 0-end association expression) is /1, it is not reducible to because it would not reflect the directionality of the association.

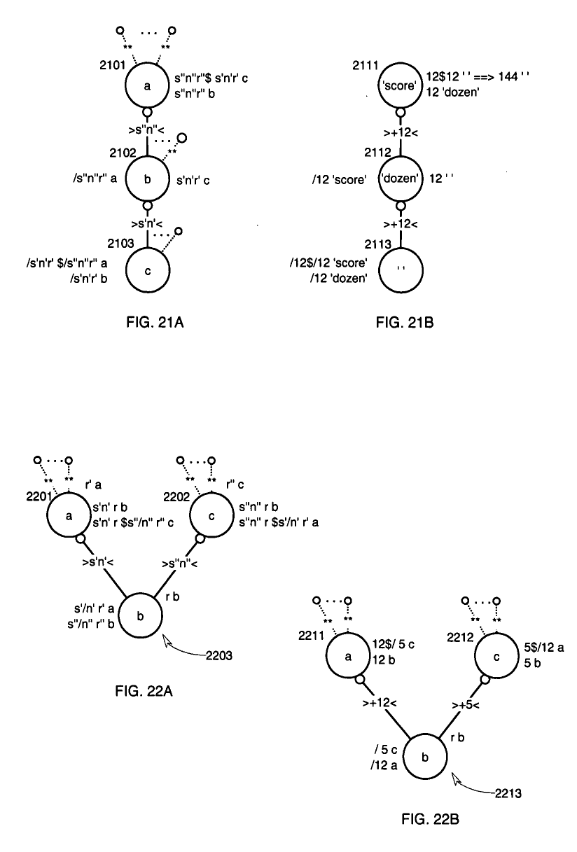

The example sequential instance summation structures in FIGS. 21A-B illustrate the item expressions and inverse item for each of the three instances in terms of each other two instances. The direction of the traverse that generated each expression can be ascertained from the presence or absence of a back slash (/), as well as its item id or content. The inverse expressions for instance 2103 (FIG. 21A) are (/s′n′r′•/s″n″r″ a) in terms of instance 2101 and (/s′n′r′b) and in terms of instance 2102. The inverse expressions for instance 2113 (FIG. 21B) are (/12•/12 ‘score’) in terms of instance 2111 and (/12 ‘dozen’) and in terms of instance 2112. The simplified form of the former item expression is (/144 ‘score’).

The example diverging instance structure in FIGS. 22A-B illustrate both item expressions and inverse item expressions for diverging items 2203 (FIG. 22A) and 2213 (FIG. 22B) and the two instances that they each define. Note that the item expressions for defined items 2201, 2202, 2211 and 2212 in terms of the other instance are inverse fractions of one another.

### B. Illustrating Expressions in Grid Form

A technique for compactly illustrating object information (an object, its class its values and each values metrics) stored in an I-A platform for one or more object, as well as entering object information, is as a rectangular grid that illustrates multiple objects, with each object's class and value information. Table 5 presents a generic example of such a grid having a header, body, and footer with the information in each cell described. Each body row illustrates information about an object, specifically its class and values. One body column illustrates the name of the class of the object with a column heading that is the name of the superclass of the objects illustrated; another body column illustrates the item expression for the existence (time) interval of the object with the column heading of ‘Time’; the remaining body columns illustrate the item expressions for each of the object's attribution values with column headings that are each the name of the metric of the values item expression in a body column. The metrics listed in each column heading are those that are applicable to the superclass. The footer illustrates an optional query specification for the objects listed in the body. The Time cell and each value cell in the body and footer each illustrate one of the following:

the item expression of the attribution value;

nothing, indicating that no value is specified; and

for non-time values, an indication that metric does not apply to the class of the object.

The body grid values are for the point in time that is illustrated above the metric names in the form of a time value expression.

TABLE 5
Generic Example of I-A Platform Information Illustrated in Grid Form

| | | | Values as of: [time value | | |
|---|---|---|---|---|---|
| | [see text] | [see text] | expression] < > | | |
| Header > | [class] | Time | [metric 1] | . . . | [metric n] |
| Body | [class or | * | * | . . . | * |
| | subclass 1] | | | | |
| | . | . | . | . | . |
| | . | . | . | . | . |
| | . | . | . | . | . |
| | [class or | * | * | . . . | * |
| | subclass m] | | | | |
| Footer > | [class or | * | * | . . . | * |
| | subclass m] | | | | |

*a value item expression or blank, and for non-time values, an indication of non-applicability

The upper header columns provide the means for the user to control what is illustrated. The upper header over [class] allows the user to restrict the classes illustrated. The upper header over ‘Time’ allows the user to restrict the time interval, e.g., to historic, i.e., those with an end Time value. The upper header over the remaining columns provides the means for the user to select the time of the values of interest. The footer contains information on the object that specifies the query (as discussed later).

Table 6 presents a non-generic example of a rectangular grid display.

TABLE 6
Non-generic example of I-A Platform Information Illustrated in Grid Form

| Subclass | | | | | | |
|---|---|---|---|---|---|---|
| types: | | | | | | |
| Direct | | | | | | |
| Motor | Time | | | | | |
| vehicle | types: | As of: Feb. 3, 2007 <> | | | | |
| by body | Historic | | | | Max. | Load |
| type | Time | VIN | Weight | Mileage | Passengers | limit |
| Auto | Apr. 20, 2001: Jul. 7, 2006 | 45LD456 | 2720 +/− 45 lb | 27 mpg | | |
| Bus | May 12, 2004: | 4KGM93 | 54~00. kg | | 42 | |
| Truck | | 03DMG15 | | 13.3 mpg | | “½ ton” |
| Motor | | | | >12 mpg | | |
| vehicle | | | | | | |

As shown in the above example:

the “< >” are buttons used to change the date/time to earlier or later;

crosshatching is used as an indication that metric does not apply to the object's class;

blank identifies the absence of value information;

shading is used as an indication that the value expression is a simplified form of a more complex expression or that other values exist for a different time;

the expression surrounded by double quotes identifies it as being implied by other information rather than stored for the subject object; and

uncertainty is expressed in a form determined by the specification of that uncertainty.

The user can open an empty grid and enter the characteristics of an object that encompasses the range of objects to be found and illustrated in the body. Not entering a query will cause all objects having the class and time interval to be found and illustrated. The user can click any accessible value body cell to open a screen illustrating either the expression or a graph of the value structure. If the cell is shaded, expression and graph illustrates the full expression, including any identical, implied expressions, and other states.

For entry, the user can add a new body row and can either directly enter an expression in any body cell or click any body cell to open an empty screen and enter a superclass and the system process managing the screen finds and illustrates the appropriate metrics. The user can open an empty grid, enter a super class and enter object information. The process precludes entry into those cells whose metrics do not apply. That process generates the applicable elements from the value information entered by the user as an expression

### V. Complex Information Structures

The following topics require the use of expressions to explain the information conveyed.

### A. Value Specification

The technique for specifying the values for a given object and metric is by a single value that is classified by the metric and is the only value with that metric having an object attribution association with the object it attributes. Such a value is called an attribution value; value 304 in FIG. 3A is an example of such a value. An attribution value is either unconfigured either with or without non-null content (e.g., value 304), or has null content and is configured to specify more complex value information.

There may or may not be an attribution value for a given object and metric, and, if there is a value, it may or may not have content. The meaning of each combination of the above cases is as follows:
if a stored attribution value has content or is configured, there is no ignorance regarding that value or its content;
if a stored attribution value has no content and is unconfigured, there is no ignorance regarding that value or its content (e.g., the middle name of a person with no middle name); and
if no attribution value is stored, there is ignorance regarding that value, and if that value is expected to have content, i.e., its content is unknown.

This technique overcomes the problem found in relational databases where the meaning of the content of an empty cell is ambiguous, i.e., it can mean that the value is either no content or that content is unknown.

Axiom 17 states that each value applicable to a given metric is known. Those values are specified by a value domain. Where each value in a value domain cannot be enumerated or stored, a value domain need store only those values that have been named and how they are defined or configured with other values (e.g., units of measure and letter grades).

The technique for specifying each value in a non-enumerated value domain is in terms of a value, called a metric unit value, representing a finite amount that value presumed to be at or smaller than some threshold of observability for that metric. Each other value in the value domain is some count of the metric unit value. Each value domain is in terms of one or more objects, called reference objects, whose values are used as a reference, e.g., the “standard kilogram” object kept by the National Institute of Standards and Technology (NIST) whose mass is used to define one kilogram. Each value domain defines each applicable unit of measure, abbreviated UoM.

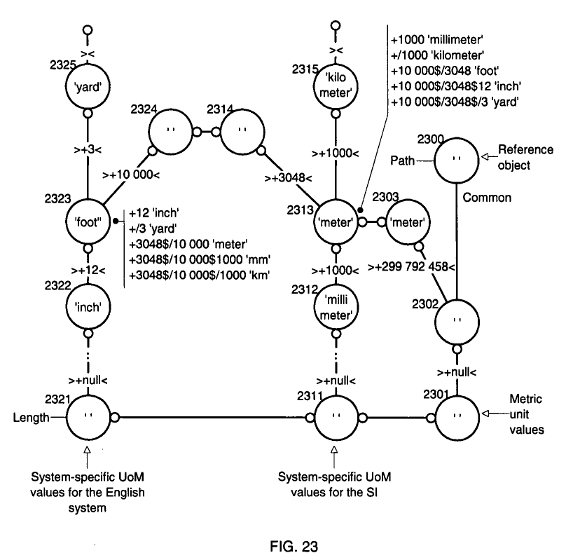

The non-generic example structure in FIG. 23 shows a portion of the value domain for Length in terms of two measure systems: the English system and the System Internationale (SI). This structure specifies how the SI is defined by a reference object, how the English and the SI are related, and defines several UoMs. The reference object and its attribution value are common instances used to define the base UoM, meter. Object 2300 is the reference object, in this case a path in space traveled by light during 1/299 792 458 of a second, and value 2302 is the attribution value for that object. Value 2303, defined as the sum of 299 792 458 of value 2302, has content: ‘meter’, i.e., the name given to 299 792 458 of the attribution value of the Length reference object. With this specification, the item expression for value 2302, the attribution value, in terms of value 2303 is +/299 792 458 ‘meter’. The Length value domain also specifies are the Length of a ‘foot’ value, value 2323, in terms of the Length of a ‘meter’ value, value 2313 through values 2314 and 2324 that specify the ratio of ‘foot’ to ‘meter’. Each measurement system shown has its sequentially-defined values: values 2321, 2322, 2323 and 2325 for the English system and values 2311, 2312, 2313 and 2315 for SI. Each measurement system as well as the reference object has its own metric unit value that form an identity network composed of values 2301, 2311 and 2321. These system-specific metric unit values allow specification of an unknown UoM when the count is unknown with a preferred measurement system. For example, storing an unknown value in terms of value 2321 specifies a preference for the English system; storing an unknown value in terms of value 2301 specifies no preference. Values 2313 and 2323 illustrate item expressions in terms of the other values having UoM content; these expressions can be seen to be conversion factors between the subject UoMs. The above domain can be extended to address UoMs in different languages as well as abbreviations (e.g., ‘mm’ for ‘millimeter’). Historic value domains, e.g., a foot defined by the King's foot (a particular object) can be specified along with its (exact or approximate) conversion factor. The plural form of a UoM can be specified by a value in its value domain with the text in that form that is defined by +null of the value having the text of the singular form of the subject UoM.

### B. Time Value Domains

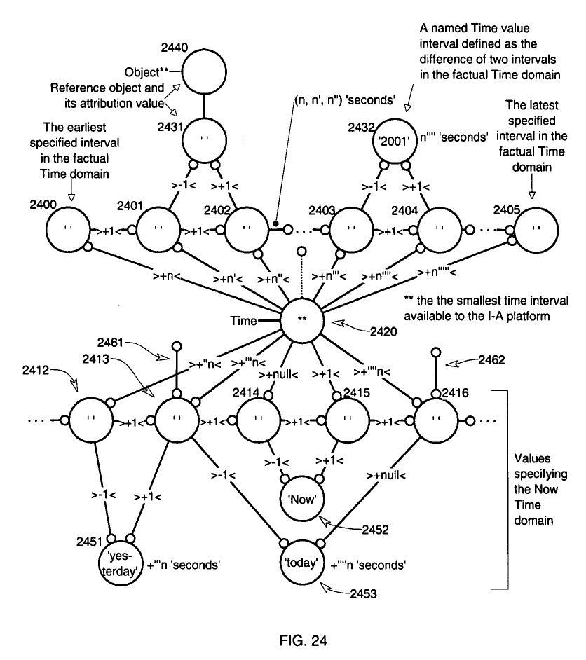

A Time value domain specifies the range of possible Time values and is used to specify the temporal existence of an object, i.e., the interval of time during which an object exists. Axiom 18 states that there are two parallel time sub-domains: one specified relative to an event object whose temporal existence is known, e.g., the birth of Christ, called the fixed time sub-domain, and the other specified relative to the present moment in time (i.e., ‘Now’), called the Now time sub-domain. These sub-domains are linked by identity associations as described below. FIG. 24 shows a simplified generic structure for a portion of each of these two Time sub-domains. Value 2420 is the Time value for the time interval for the smallest time interval available to an I-A platform (i.e., one click of the system clock) and the other Time values shown are defined in terms of a count of that time interval. Object 2440 is the reference object, e.g., the birth of Christ, for the fixed Time sub-domain and Time value 2431 is its attribution value. Time values 2400, 2401, 2402, 2403, 2404 and 2405, among others, represent the cumulative time sequence from the earliest specified time to the latest specified time, here specified as from value 2400 to value 2405. The technique of specifying a time interval is by a value defined as the difference between two values in the cumulative time sequence. Value 2431 is a interval Time value, in this case the attribution value for the reference object, that is defined as including value 2402 and excluding value 2401. Value 2432 is a named time internal value specifying the year 2001 identified by its content, i.e., it is the name of that interval in the cumulative time sequence. A named time interval value with a calendar date is called a date value. A date value can be specified for a millennium, a year, a month in a given year and a date in a given month and year. Value 2402 has an item expression that is the cumulative time since the start of the earliest specified time interval in the cumulative sequence of time; value 2432 has an item expression that is the difference between two values in the cumulative time sequence, which, in this case, simplifies to n″″. The Now Time sub-domain has a no reference object, rather it is specified relative to the ‘Now’ value shown as value 2452. Count ″″n on the association from value 2420 to value 2414 is the count of the clicks of the system clock since the beginning of ‘today’. The Now Time sub-domain also has a cumulative sequence of time from the earliest specified time to the latest specified time. An intermediate portion of that sequence of time is represented by values 2412, 2413, 2414, 2415 and 2416. Other named interval Time values are value 2451 having content ‘yesterday’ and value 2453 having content ‘today’. Identity associations 2461 and 2462 specify those cumulative time sequence values that are identical for the beginning and ending of ‘today’.

The technique for specifying the temporal existence of an object in either Time sub-domains is by one of the following: a named interval Time value, e.g., value 2432; or the difference of two such values, either specified or implied.

An object has its temporal existence specified with respect to the fixed Time value domain with a start Time value later than ‘Now’ is a future object. An object has its temporal existence specified with respect to the fixed Time value domain with a start Time value later than ‘Now’ is a factual object, i.e., its existence is or was a fact. An object that has its existence specified with respect to the ‘Now’ Time value domain with a start Time value of ‘Now’ or later than ‘Now’ is an expectational object. An expectational object represents an object that could exist in the future along with its characteristics and configuration with other object as discussed later. An object without a start Time value is presumed to have a start Time value before ‘Now’ and is a factual object; an object without an end Time value is has an implied end Time value of ‘Now’ and is a factual object called a current object.

A future object can be specified as real or virtual. If it is specified as virtual, the future object represents what is planned. If it is not specified as virtual, an I-A platform system treats it as if it were virtual until its start Time value is earlier than ‘Now’ at which time the object becomes factual. A real future object can be used to initiate a process that is executed when its start Time value is the same as ‘Now’.

### C. Spatial Value Domains

A spatial value domain specifies the range of possible Length values in a given dimension and is used to specify the spatial existence of an object in that dimension, i.e., the interval of in that dimension in space where an object exists. Each spatial value domain specifies each possible Length values in terms of different pairs of reference objects, i.e., physical objects whose spatial locations are known and used provide a reference for all other objects using that domain. Each spatial value domain may be a component of one or more spatial domain systems, each used to specify a position in three dimensions. Axiom 19 requires that each spatial domain system be composed of orthogonal spatial domains. Each spatial domain system can be linked by an identity association that either permanently or momentarily specifies the mapping of spatial values in another system. A structure specifying a spatial value domain has the same pattern as the fixed Time value domain shown in FIG. 24, with a Length metric instead of a Time metric.

### D. Value and Membership Variation

Since a value is not attributed by other values, the variability of one value of an object with respect to another cannot be directly specified in that manner. The technique for specifying different values for an object over time (temporal variability) is by specifying objects that are each disjoint and non-overlapping temporal portion of the object exhibiting that variability. These portion objects are called state interval objects because each specifies the state of the object during a specified time interval. The state interval objects have contiguous and disjoint temporal existences. Each state interval object has the values, members or products, or combination thereof, that apply during its time interval.

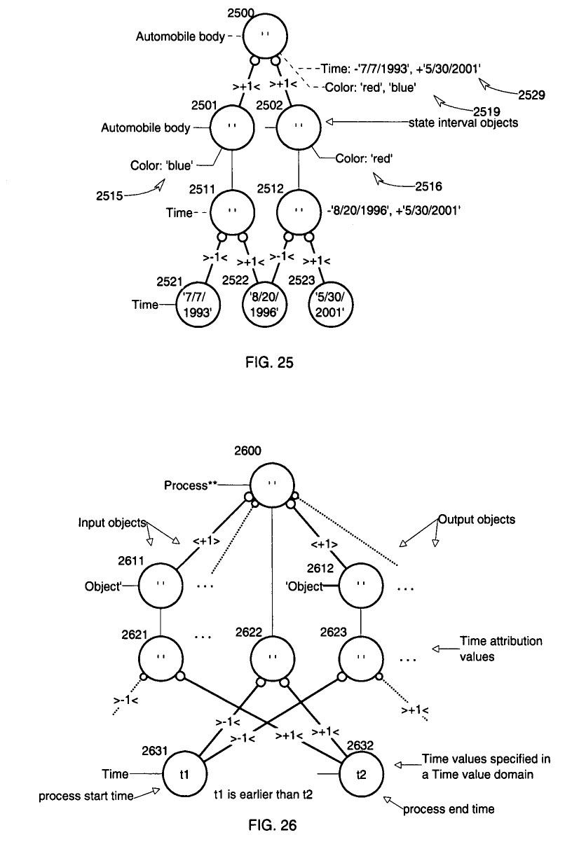

FIG. 25 shows a non-generic example structure specifying an automobile body object with two different colors during different contiguous time intervals. Object 2500 is the sum Automobile body object that has two portion objects, objects 2501 and 2502 that at as state interval objects. These two objects are attributed by Color values 2515 and 2516, and by Time values 2511 and 2512. Object 2501 has Color value: ‘blue’ and object 2502 has Color value: ‘red’, both illustrated in simplified form. Time value 2511 specifies the temporal existence of object 2501 defined as the difference of the Time values 2521 and 2522, i.e., Jul. 7, 1993 to Aug. 20, 1998; Time value 2512 specifies the temporal existence defined by the difference of Time values 2522 and 2523, i.e., from Aug. 20, 1998 to May 30, 2001 as shown by the item expression for Time value 2512. Time values 2521, 2522 and 2523 are date values defined in the fixed Time sub-domain in the same manner as Time value 2432 in FIG. 24. Since Time values 2511 and 2512 are each defined by Time value 2522, those two Time values are contiguous and disjoint. Sum object 2500 has implied Color value 2519 and implied Time value 2529, the latter being the difference of Time values 2521 and 2523, i.e., from ‘Jul. 7, 1993’ to ‘May 30, 2001’.

### E. Processes

A process is understood in terms of its inputs and output objects where the input objects and output objects have the same or overlapping (spatial and temporal) existence and during the process the temporal existence of one or more objects begins or ends, or any combination thereof, i.e., objects are created or terminated, or both. A process is either a physical process (e.g., Combustion whose inputs include a fuel that is destroyed and outputs include heat that is created) or an informational process (e.g., a financial transaction whose inputs include an ownership of an object that is terminated and whose outputs include an ownership of an object that is created). Multiple processes can be nested with or without recursion to create a process of any complexity.

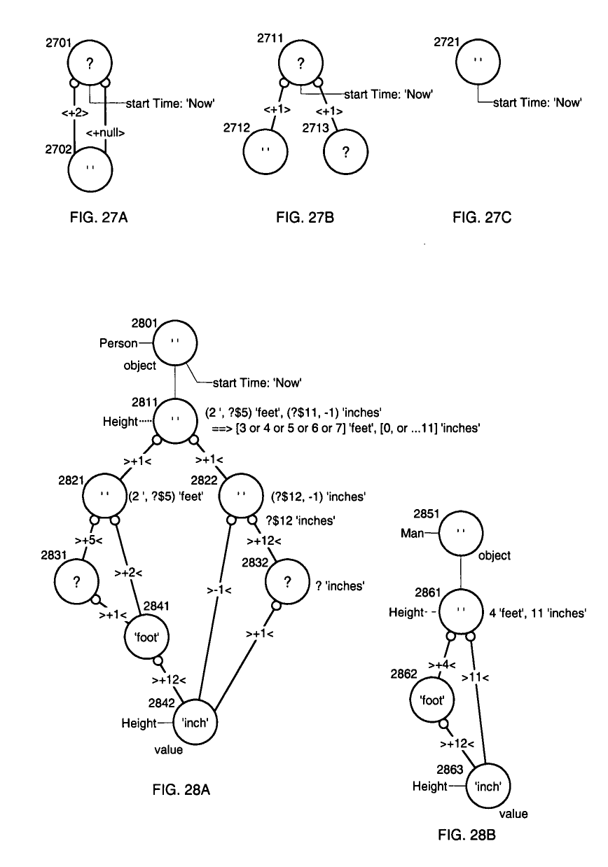

The technique for specifying a process is described by the pattern shown in FIG. 26. Object 2600 is a product object representing the process as a whole and is classified by a subclass of Process (i.e., Process**) and has a specified Time interval. Object 2611 is one input object among one or more such objects; object 2612 is one output object among one or more such objects. Value 2622 is the Time attribution value for the process specified as the difference between Time value 2631 and Time value 2632, the process object's start Time value and end time value, respectively. Each input object has a start Time value earlier than that of the process object and each output object has an end Time value later than that of the process object.

During a given process: one or more input object must have an end Time value that is the same as that of the process object; one or more output object must have a start Time value that is the same as that of the process object; or some combination thereof. Value 2621 is the Time attribution value for an input object specified as having its existence ended at the end of the process and value 2623 is the Time attribution value for an output object specified as having its existence begun at the start of the process. Not shown in the pattern in FIG. 26 are any objects that is unaffected by the process (e.g., an object that is the subject of a change of ownership during a financial transaction process). Such an object is a member of the process and is regarded as both an input and an output object because it's temporal existence earlier than value 2631 and later than value 2632.

### F. Constraints

A constraint describes what is and is not allowed to be stored in a platform. When information is stored contrary to a constraint, an I-A platform either handles it internally, possibly reporting an error, or warns the user to confirm that the information is valid and override the constraint before taking any action.

In an I-A platform, a constraint is either implicit or explicit. An implicit constraint is implemented by the system managing an I-A platform; an explicit constraint is stored in a platform as a structure. The implicit and explicit constraints in an I-A platform are discussed below.

### 1. Implicit Constraints

The following constraints are enforced by an I-A platform and cannot be overridden. Some of these constraints arise from an axiom. Additional constraints may be imposed by applications that manage the content of an internal instance, e.g., a word processor application.
1) Each item_id generated by or introduced into a system is unique among all simultaneously-accessible items;
2) Each association end must have a valid item_id;
3) Each instance must be classified by one real concept, either directly or through other instances;
4) Two identical instances must be classified by the same concept;
5) Each specific metric must be associated with one class;
6) A value must be classified by a specific metric;
7) The sign and count attributes can only store characters applicable to those attributes (item_id and content are allowed to be any bit string);
8) Each pair of non-identical items must be distinguishable from one another;
9) An item cannot configure itself indirectly through other items except through identity associations;
10) A concept and a particular instance can configure another instance only once;
11) For a given object and applicable metric, there can be only one value having an object attribution association with that object;
12) A specific value configuring an attribution value must be that value's value domain;
13) The metrics of a given class are only those associated with it and those associated with its superclasses (i.e., the latter metrics are inherited);
14) An object may have only one start Time value and may have only one end Time value and difference of those values must be positive.

### 2. Explicit Constraints

An object with a given class and values has no direct constraint on how many members it may have, or the class and values of each of its members. In addition, an object of a given class and value has no direct constraint on how may product objects it may have, or the class of those products. Finally, a value for a given metric can take on any value in that metric's value domain.

The technique for specifying constraints on members, products and values of an object with a given class and values is by specifying what we expect of any object having the given class and values. An object representing what we expect is an expectational object, described earlier, that has its existence specified with respect to the ‘Now’ Time value domain with a start Time value of ‘Now’ or later than ‘Now’. Since an expectational object is what we expect of any object having the given class and values, it is necessarily a common object. A structure having an expectational object specifies an expectation of an object stored in an I-A platform.

An attribution value of an expectational object specifies one or more of the following. For non-quantitative values, it is one or more specific values (e.g., the Color value of a Lemon object or the Color values of a Leaf object). For quantitative values, it is configured by values specifying a single quantitative value or a range of values (e.g., mass between 10 kg and 25 kg). Any uncertainty specified in a quantitative expectational attribution value is its precision.

An I-A platform system can compare a non-expectational object, its characteristics and its configuration to an expectational object having specified characteristics and configuration to determine whether or not the non-expectational object “meets expectations”. The former object can be either the same class or a subclass of the latter. If it fails in this regard, an I-A Platform can store that object as virtual or warn the user. If the user overrides a warning, the system can update the expectation as appropriate.

FIGS. 27A-C show three generic example structures with expectational objects showing the technique for specifying constraints on members and products of objects.

In FIG. 27A, object 2701 is an uncertain expectational common product object that is produced by more than two of common member object 2702. Object 2701 is expectational because its start Time is ‘Now’. Only the product object is expectational; the member objects have no specified existence, but since they precede the product object they must be earlier than ‘Now’, i.e., they are factual. This structure specifies the following: any object with the class or subclass and values (not illustrated) of object 2701 must be a product object having three or more of member objects with the class or subclass and its values (not illustrated) of object 2702; and any object with the class or subclass and its values of object 2702 may be a member of product object 2701. Object 2702 may be a member of product object 2701 because that object may or may not be real.

In FIG. 27B, object 2711 is an uncertain expectational common product object that is produced by common member objects 2712 and 2713. This structure specifies the following: any object with the class or subclass and values (not illustrated) of object 2711 must be a product object with one member object with the class or subclass and its values (not illustrated) of object 2712 and may have one member object with the class or subclass and its values (not illustrated) of object 2713; any object with the class or subclass and values of object 2712 may be a member of product object 2701; and any object with the class or subclass and its values of object 2713 may be a member of product object 2701. Product object 2701 may have object 2703 as a member because object 2703 may or may not be real.

In FIG. 27C, object 2721 is an expectational common specific object that may not be a member of a product object or be a product object itself.

The structure in FIG. 28A illustrates a non-generic example expectational structure that specifies the range of values for an expectational object for the Height values of any Person object. The specified range is from 3 ‘feet’ 0 ‘inches’ to 7 ‘feet’ 11 ‘inches’, stored in increments of 1 inch. Object 2801 is the expectational Person object. Value 2811 is the object's expectational common attribution value. Value 2811 is defined by values 2821 and 2822: the former is a range of values defined in terms of value 2841, the ‘foot’ value in the Length value domain (FIG. 23 value 2323); the latter is a range of values defined in terms of value 2842, the ‘inch’ value in the same value domain (FIG. 23 value 2322). Values 2831 and 2832 are an uncertain ‘foot’ value and an uncertain ‘inch’ value, respectively. The item expressions for value 2832 and value 2822, and the 0-end association expression for the association between those two values, describe how the structure specifies the range of values for inches.

The structure in FIG. 28B illustrates a non-generic example factual structure that meets those expectations. That structure specifies that a Person object has a Height value of 4 ‘feet’ 11 ‘inches’. Object 2851 is the Person object and value 2861 is its attribution value. The attribution value is defined by ‘foot’ values and ‘inch’ values where the ‘foot’ value (value 2862) and the ‘inch’ value (value 2863) are the same as values 2323 and 2322 in FIG. 23, respectively.

### G. Expectational Processes

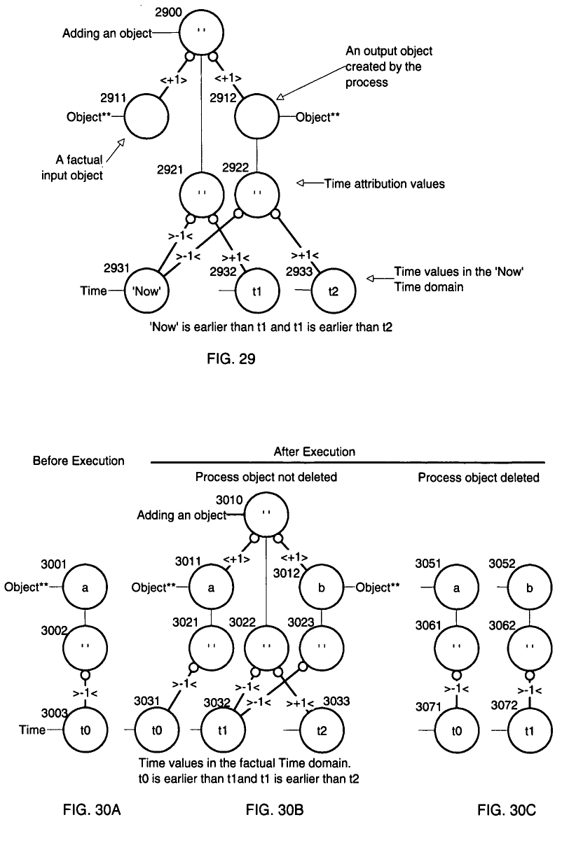

As described earlier, a process is either a physical or informational process. In addition, a process is one of the following: a factual process, a future process (e.g., an agreement to sell a house that has yet to be completed) or an expectational process. An expectational object, whether a process object or an output object, has a start Time value of ‘Now’ and an end Time value some time later than ‘Now’. FIG. 29 illustrates a generic example expectational process structure that specifies that an output object is created when there is a factual input object, i.e., has a temporal existence earlier than ‘Now’. Object 2900 is the expectational process object because its Time attribution value, value 2921, has a temporal existence defined by the start Time value of ‘Now’ (2931) and an end Time value later than ‘Now’, value 2932. Object 2911 is a factual input object because it has no Time attribution value and, as described earlier, absence of a specified temporal existence implies an existence starting earlier than ‘Now’ and an end Time value of ‘Now’. Object 2912 is an expectational output object because its Time attribution value, value 2922, has a start Time value of ‘Now’, value 2931, and an end Time value later than the end of the process, value 2933.

As discussed earlier, an expectational structure can be used to enforce explicit constraints in an I-A platform. Another use is as means of adding, changing and deleting elements in an I-A platform. One such use is as a template for entering information, i.e., copy the structure and allow the user to edit it to specify the subject information. This procedure is handled in conventional information systems by either manually adding a record to a relational database table whose metrics are predefined and constraints are in place, or is built into a data entry screen that provides a means of entering information that is consistent with a previously specified organization and ensures that the constraints are enforced. Such screens are used for both process information (i.e., a financial transaction) and non-process information (e.g., a person and their roles).

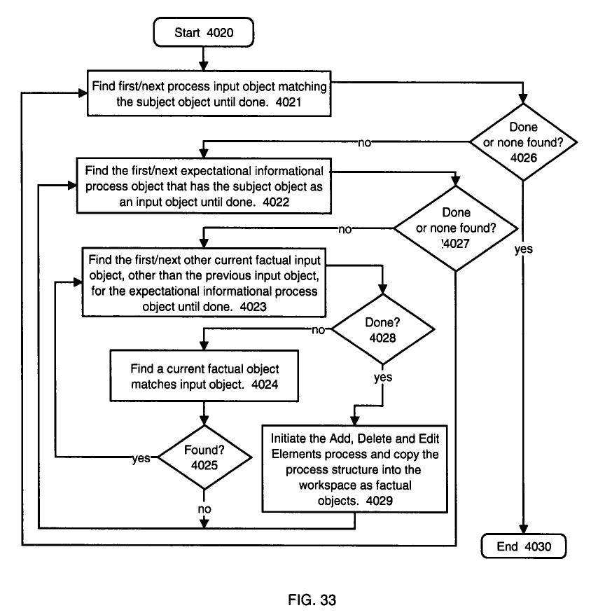

Another use of an expectational structure as a means for adding, changing and deleting elements in an I-A platform is to automatically make the changes specified in an expectational informational process. Such automatic changes are handled in conventional information systems through execution of process logic, i.e., software. In an I-A platform, such automatic changes are made by the Execute an Informational Process system process that is executed whenever all of the input objects are current objects. One embodiment of an Execute an Informational Process method is described below in conjunction with FIG. 33.

FIGS. 30A-C illustrates three generic example structures for the input object. The structure shown in FIG. 30A is at a time before the Execute an Information Process system process is initiated, and the other two structures shown in FIGS. 30B and 30C are after it has completed. Before it is initiated, object 3001 is an object added to an I-A platform with a start Time value of ‘t0’ but no end Time value. The Execute an Information Process system process identifies object 3001 as having been added and finds that the expectational informational process structure (FIG. 29) has an input object having the same characteristics (i.e., the same class or a superclass, the same reality, the same content, the same values or within the specified value range and the same configuration) as object 3001. The Execute an Information Process system process copies the objects and values in the expectational process structure that are not already stored as factual objects as shown in FIG. 30B. Items 3011, 3021 and 3031 are items 3001, 3002 and 3003 respectively. Factual instances 3010, 3022, 3012 and 3023 are copied from the expectational object structure. Time values 3032 and 3033 are Time values used to specify the start time (t1) and the end time (t2) of the system process, i.e., the time during which the objects and values were copied from the expectational process structure (FIG. 29) to generate the factual process structure shown in FIG. 30B.

The structures in FIG. 30C illustrate the elements that would remain if the process elements were subsequently deleted. Items 3051, 3061 and 3071 are items 3011, 3021 and 3031 respectively, and items 3052, 3062 and 3072 are items 3012, 3023 and 3032, respectively. Keeping process object 3010, its attribution value 3022 and their associations, preserves all information about the process, allowing it to be rolled back if needed.

### H. Specifying a Query

A query is technique for finding objects stored in a platform that have characteristics of interest: class or subclass, content, reality, values and configuration with other objects; those characteristics are also referred to as search criteria. The technique for determining if an object proposed for addition to an I-A platform is unique, i.e., it is not a duplicate of a previously stored object, is a system validation process. These two techniques are the same, differing only in characteristics of the added object, and the interpretation and use of the result of the process. These techniques are implemented in an I-A platform by the Duplicate/Query process described subsequently. As shown below, query object is necessarily a virtual object to prevent it from being used incorrectly by other processes. When an object is added, the Duplicate/Query process adds a configuration association from the found stored object to the added object. The result of that process is one of the following:
a) there are no stored objects having the specified characteristics; if the added object is virtual, it is ignored by other processes; if it is not virtual, the object is unique and is a new stored object;
b) there is one stored object having the specified characteristics, in which case the added object is a duplicate of the found object; and
c) there are multiple stored objects having the specified characteristics, in which case the added object is defined by those found objects.

### If the added object is virtual, the output of the process is a query result; if not virtual, the output of the process is a new stored object or a list of duplicates to be resolved.

### VI. Management System

The technique for managing the information stored in an I-A platform is a system, called the I-A management system, composed of the following interdependent system processes that work in concert with one another:
1) Add and delete elements, and change their attributes;
2) Validate elements proposed to be stored consistent the axioms of information, including enforcing explicit constraints discussed earlier; and
3) Execute logical processes stored as expectational informational structures.

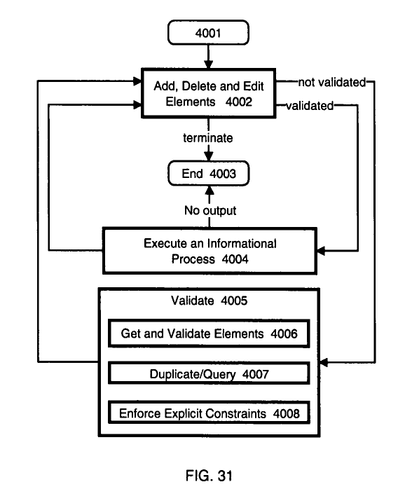

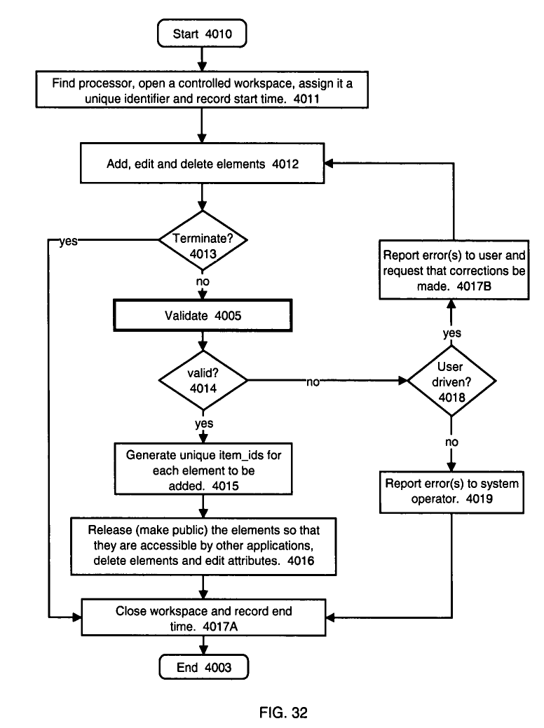

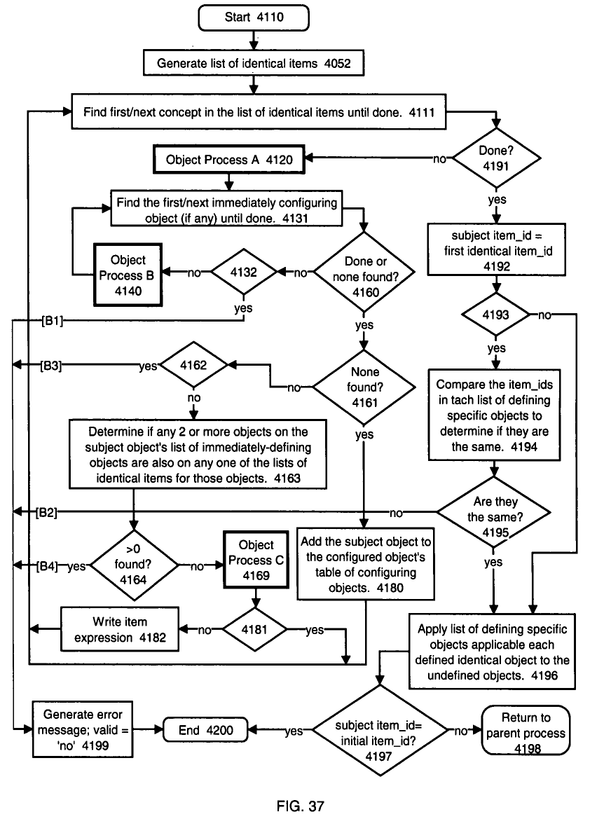

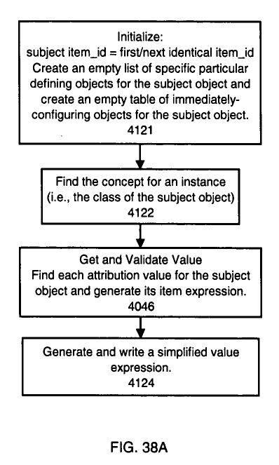

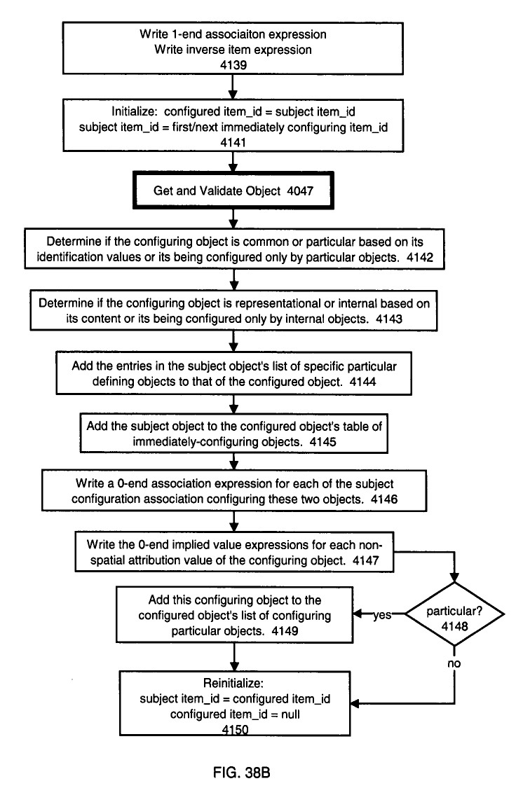

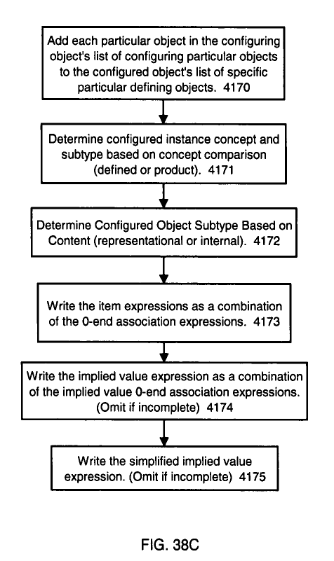

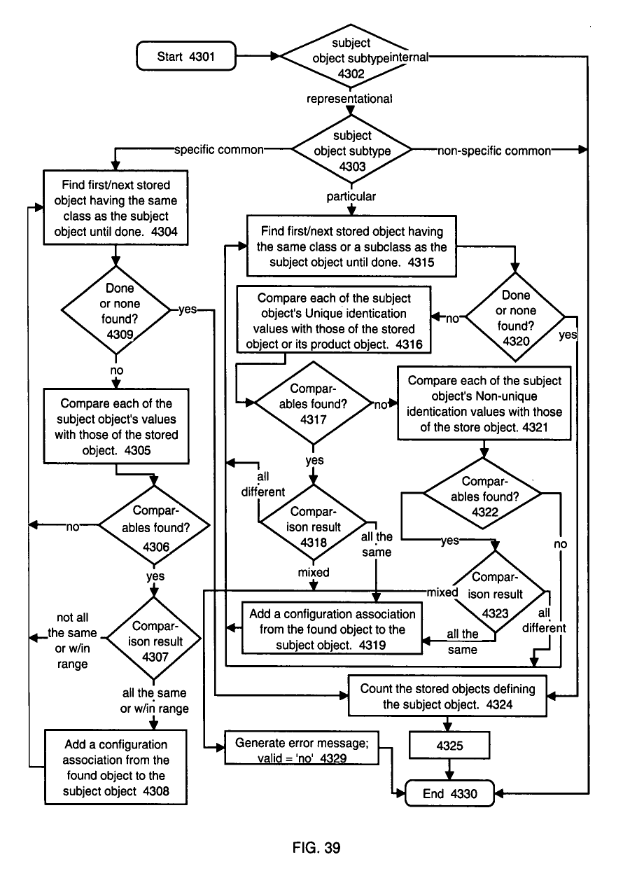

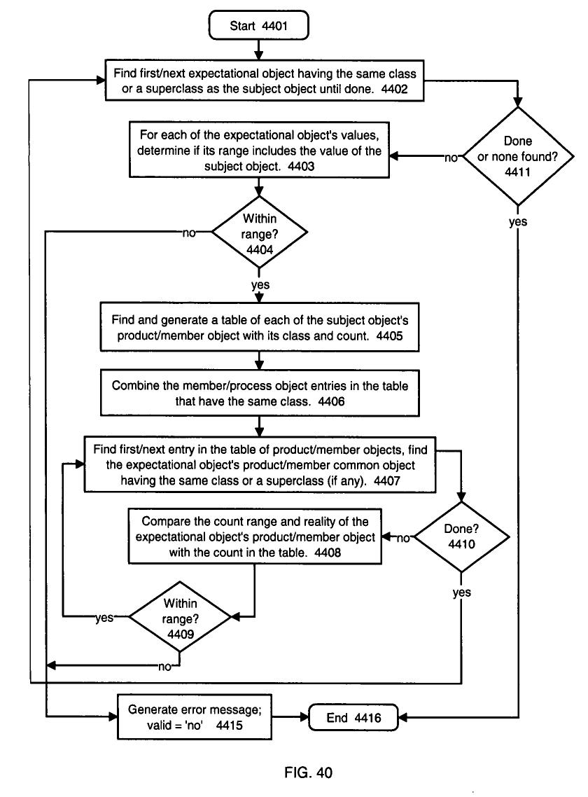

The interdependence of these system processes is illustrated in one embodiment in FIG. 31 as a flowchart of corresponding computer-implemented methods. A block with a bold outline represents a sub-process. An action by the I-A management system is started by an external request (block 4001) that sends a requests to an Add, Delete and Edit Elements method (block 4002), by an object whose start Time becomes earlier than Now, or by output generated by an Execute an Informational Process method (block 4004). The Add, Delete and Edit Element method represented by block 4002 controls all changes to the elements stored in an I-A platform and initiates the Validate process (block 4005). The Execute an Informational Process method (block 4004) is initiated by the presence of new or edited elements and either generates output (elements to be added, deleted or edited) as described earlier or terminates if no there is no output (block 4003). A Validate method (block 4005) is composed of three sub-processes 4006, 4007, 4008 that can be executed concurrently. The Get and Validate Element method 4006 is described in more detail below in conjunction with FIGS. 37 and 38A-C. The Duplicate/Query method 4007 is described in more detail below in conjunction with FIG. 39. The Enforce Explicit Constrains method 4008 is described in more detail below in conjunction with FIG. 40. The Add, Delete and Edit Elements method 4002 is described in more detail next in conjunction with FIG. 32. The Execute an Informational Process method 4004 is described in more detail below in conjunction with FIG. 33.

The I-A management system of FIG. 31 is recursive in two ways. One recursion (block 4002 to block 4005 and back to block 4002) continues to validate the elements until all errors are removed or the user terminates (block 4003). The other recursion (block 4002 to block 4004 and back to block 4002) executes informational processes for validated elements until it generates no output and terminates (block 4003), or until the Add, Delete and Edit Elements method 4002 finds an error and terminates (block 4003).

### A. Add, Delete and Edit Elements Method

FIG. 32 is a flow chart illustrating one embodiment of the Add, Delete and Edit Elements method 4002. The Add, Delete and Edit Elements method provides the back-end to user interfaces for adding, deleting and editing elements in an I-A platform, as well as handling an object whose start Time becomes earlier than Now or by output generated by the Execute an Informational Process method (block 4004 of FIG. 31). When requested by a user (who wishes to add information directly or consistent with the constraints specified by an expectational structure, i.e., an entry screen) or the system (because of a user request to load information consistent with the I-A storage model that is stored elsewhere) (block 4010), the system finds an available processor, open a new workspace in that processor setting start Time to ‘Now’ (start Time is presumed to be unique for each workspace) and identify the user (userid or the system) and the processor involved (block 4011). Elements added to that workspace are controlled, i.e., not accessible to other users/process. The user can enter elements and find those to be edited or deleted (block 4012). A user can terminate at any time (block 4013). When complete, the Add, Delete and Edit Elements method initiates the Validate method (block 4005 of FIG. 31) and handles the messages received from that method. If valid (block 4014), item_ids are assigned (block 4015) and elements are released and made accessible to other user/process as well as delete those marked for deletion (block 4016). If not valid and user driven (block 4018), an error message is displayed requesting the user to correct the entries by editing the elements (block 4017B). If not valid, and not user driven, the errors are reported to the system operator (block 4019). When elements are released, when requested by the user or when errors are found without a user, the workspace is closed and the end time of the method is recorded (block 4017A) and the method ends (block 4003).

### B. Execute an Informational Process Method

An informational process is a process object whose members are input objects and output objects that do not represent physical objects. The Execute an Informational Process method 4004 uses expectational informational processes to generate output objects that are expected to come into existence when each of its input objects are current objects.

One embodiment of the Execute an Informational Process method is shown in FIG. 33. The method starts (block 4020) when the Add, Delete and Edit Elements method (block 4002 of FIG. 31): (1) adds a non-virtual current object; (2) changes the attribution value or content of a non-virtual current object; or (3) reconfigures a non-virtual current object. The method of FIG. 33 also starts when a non-virtual future object becomes a factual object because its start Time value changed from being later than ‘Now’ to earlier than ‘Now’. At block 4021, the method finds each input object of an expectational informational process object that has (1) the same class or a superclass of the subject object's class, (2) the same content as the subject object, and (3) attribution values that each specifying the same value or range of values that encompass the subject object's attribution value. For each input object found (block 4026), at block 4022 the method finds each expectational informational process object having that object as an input object (an input object can be input to more than one process). For each expectational informational process object found (block 4027), at block 4023 the method finds each other input member object for the expectational process object. For each input member object found (4028), at block 4024 the method finds a current object that has (1) the same or a subclass of the input object, (2) the same content as the input object, (3) attribution values that each specify the same as or within the value range of the input object values, and (4) the same configuration associations with the other input objects. If any one input member object does not match a current object (block 4025), the subject process cannot be executed and the next expectational informational process object is interrogated. Otherwise at block 4029 the method initiates the Add, Delete and Edit Elements method (block 4002 of FIG. 31), opens a workspace and copies the process structure, its output objects and values into that workspace and converts the process object and values, and the output objects and values to factual objects. If no applicable expectational informational processes are found, the method does nothing. The method ends at block 4030.

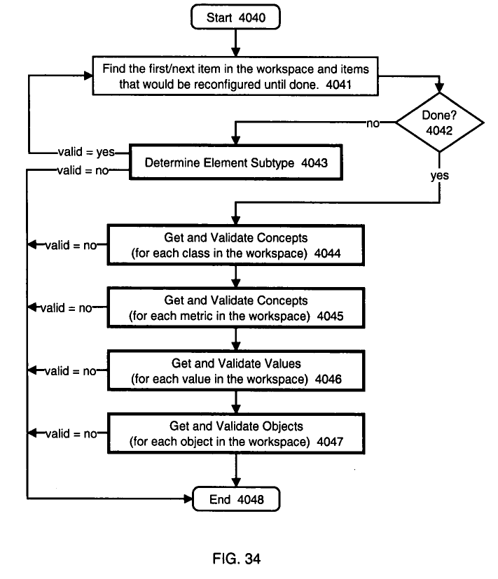

The Get and Validate Elements method (block 4006 of FIG. 31) is one of three independent validation processes, and may be composed of several sub-processes. In the embodiment shown in FIG. 34, the method starts (block 4040) when the Add, Delete and Edit Elements method (block 4010 of FIG. 31) adds or changes an object in an I-A platform. At block 4041, the method finds each item in the workspace and each item that would be reconfigured by the addition of those items or by the deletion or editing of items already in an I-A platform. The Determine Element Subtype method (block 4043) determines the item subtype based on non-configuration associations (class, object, metric or value) and identifies errors. When each item subtype has been determined (block 4042), each item subtype is analyzed by its corresponding “get and validate” method, one embodiment of which executes blocks 4044, 4045, 4046 and 4047 in the sequence shown. Each of these methods traverses the elements configuring the subject item, finds errors and generates expressions. When an error is found, an appropriate message is generated for use by the initiating Add, Delete and Edit Elements method (block 4002 of FIG. 31), valid is changed from ‘yes’ to ‘no’ and the method returns to the initiating method when it ends (block 4048). The Get and Validate Values method (block 4046) performs operations similar to the Get and Validate Objects method (block 4047) except that it applies to values. The Get and Validate Objects method is described further below.

### C. Determine Element Subtype Method

In one embodiment, the Determine Element Subtype method (block 4043) performs the following actions, which one of skill in the art will readily understand without illustration. This method is initiated by the Get and Validate Elements method (4006 of FIG. 31).

For each association, other than an identity association:
a) if it has a sign and count, it is an instance configuration association and the items on each end, including items identical thereto, are instances;
b) if it has a sign only, it is a concept configuration association and the items on each end, including items identical thereto, are concepts;
c) if it has neither a sign nor a count, it is a non-configuration association.

For each non-configuration association, if it has a concept on one end and an instance on the other, it is a classification association; otherwise it is an attribution association;

For each item:
a) if it is on the 0-end of a classification association and it has one or more concept configuration associations, it is a class;
b) if it is on the 0-end of a classification association and it has one or more instance configuration associations, it is a metric;
c) if it is on the 1-end of a classification association and it has one or more concept configuration associations, it is a value; and
d) if it is on the 1-end of a classification association and it has one or more instance configuration associations, it is a object.

For each association, other than an identity association:
a) if it is a concept configuration association with a class on either end, it is a class configuration association;
b) if it is a concept configuration association with a metric on either end, it is a metric configuration association;
c) if it is an instance configuration association with an object on either end, it is an object configuration association;
d) if it is an instance configuration association with a value on either end, it is a value configuration association.

For each item whose item subtype has yet to be determined, repeat the following until all items have their subtype determined:
a) if it is on either end of a class configuration association or on the 0-end of an object classification association or the 0-end of a class attribution association, it is a class;
b) if it is on either end of a metric configuration association or on the 0-end of a value classification association or the 1-end of a class attribution association, it is a metric;
c) if it is on either end of an object configuration association or on the 1-end of an object classification association or the 0-end of an object attribution association, it is a object;
d) if it is on either end of a value configuration association or on the 1-end of a value classification association or the 1-end of an object attribution association, it is a value;

### If an element has no subtype, an error message is generated and set the valid to ‘no’.

The item subtype and association subtype generated by the above method can be stored either temporarily (as a feature of an I-A platform implementation) or permanently using an item subtype or association subtype, or both as optional element attributes as discussed in the description of the I-A storage model.

### D. Get and Validate Concepts Method

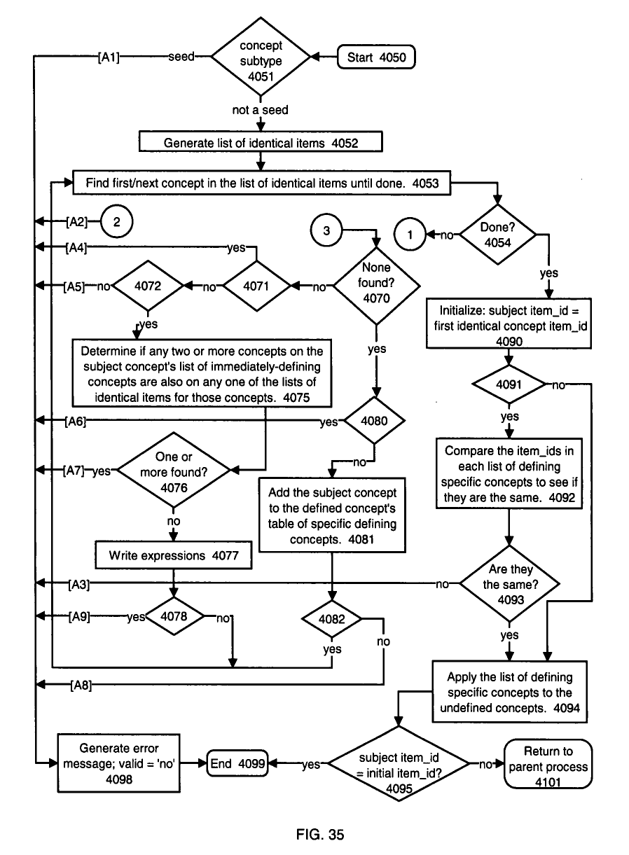

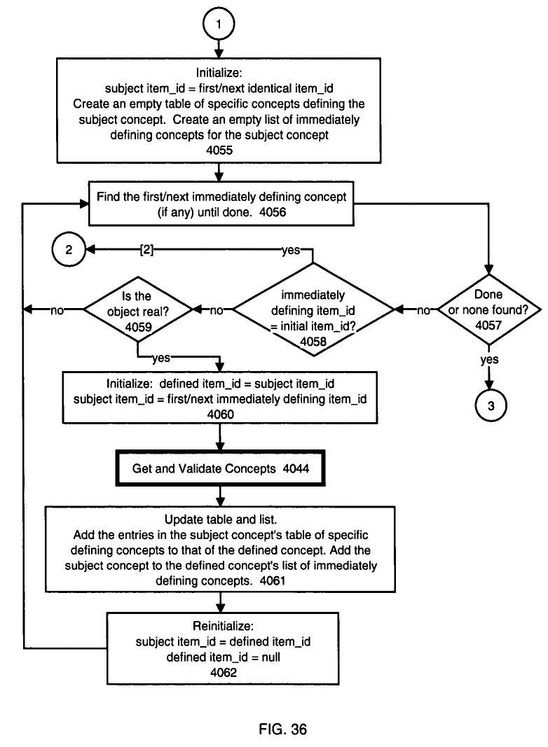

One embodiment of the Get and Validate Concepts method is illustrated in FIG. 35 and FIG. 36. This method, and the other “get and validate” methods 4046, 4047, traverses the items and configuration associations specifying how the subject item is configured by other items. The method traverses that structure along a path having the following characteristics: the path starts and ends at the subject item. The path reverses its direction at each of the leaf items in that configuration structure and returns along the same configuration association in the opposite direction. The path traverses each configuration association and each identity association twice: once in each direction. Each non-root item is traversed twice and each leaf item is traversed once. As an item or a configuration association is traversed the first, its respective inverse item expression or 1-end association expression is generated. As a non-leaf item or a configuration association is traversed the second time, its respective item expression or 0-end association expression is generated. The method calls itself for each other item traversed when first encountered.

This method determines compliance with the following implicit constraints and generates an error messages if not in compliance. Those constraints are listed below described in terms of concepts. The preceding bracketed letter and number are shown on the flowchart path followed when that error is found.
[A1] A concept cannot be a seed (i.e., it must have context);
[A2] A structure cannot be recursive;
[A3] Identical concepts must be defined by the same specific concepts;
[A4] In order to be disjoint, a concept cannot configure another concept more than once either directly or indirectly through intermediate concepts;
[A5] The concepts immediately-defining a given concept must have different non-empty content;
[A6] Among a concept and its immediately-defining leaf concepts there can be no more than one concept with empty content;
[A7] In order to be disjoint, two concepts immediately-defining a concept can't be identical;
[A8] A specific metric has one and only one class attribution association; and
[A9] A defined metric has no class attribution associations.

The Get and Validate Concepts method of FIG. 35 is initiated by the Get and Validate Elements method (FIG. 31 block 4006), at least once for classes (FIG. 34 block 4044), and at least once for metrics (FIG. 34 block 4045). The method starts (block 4050) with the following data being passed from the initiating method: an initial item_id, a subject item_id that is set to be the same as the initial item_id and a defined item_id that is empty. Constraint [A1] is evaluated (block 4051). If valid, a Generate List of Identical Items function (block 4052) generates a list of identical concepts for the subject concept, i.e., each concept in an identity network, where the list has only the subject item_id if there are no identical concepts. The Get and Validate Concepts method finds the subject item_id and each concept identical to it (block 4053). Turning now to FIG. 36, for each of these concepts in turn, the method initializes the subject item_id, creates an empty list of the item_ids of the immediately-defining concepts applicable to the subject concept and creates an empty table of the item_ids and content of the specific (leaf) concepts that directly or indirectly define the subject concept (block 4055). The method finds the first concept immediately-defining the subject concept (if any) (block 4056). For each defining concept found, constraint [A2] is evaluated (block 4058) as well as whether the concept is real (block 4059). If valid and real, the parameters are initialized as follows: the defined item_id is set to the subject item_id and the subject item_id is set to the immediately defining item_id. Since a new concept has been found, the method calls itself (block 4044) creating a child Get and Validate Concept method. When the child method returns to this (parent) method (block 4101 of FIG. 35), the parent method updates the entries in the subject concept's table of specific defining concepts to that of the defined concept and adds the subject concept to the defined concept's list of immediately-defining concepts (block 4061). The method reinitializes the parameters by returning the subject item_id and the defined item_id to their previous entries (block 4062). The method finds the next immediately defining concept (block 4056). The method determines if there are additional immediately-defining concepts (block 4057). If not, the method returns to block 4070 in FIG. 35 to determine whether or not any were found. If none were found, the concept is the initial concept or a defining leaf concept; otherwise constraints [A4] and [A5] are evaluated (blocks 4071 and 4072). At block 4071, the method determines if the same concept is found in the subject concept's table of specific defining concepts more than once (constraint A4). At block 4072, the method determines if the non-empty contents in the subject concept's list of immediately-defining concepts all different (constraint A5). If both constraints are valid, the method determines if any two or more concepts on the subject concept's list of immediately-defining concepts are also on any one of the lists of identical items for those concepts. Constraint [A7] is evaluated based on that determination (block 4076). If valid, two item expressions are written (block 4077), one in terms of the immediately-defining concepts from the entries in the list of immediately-defining concepts and the other in terms of the specific (leaf) concepts from entries in the table of specific defining concepts. Constraint [A9] is evaluated (block 4078) to determine if the general metric has an attribution association. If valid, the method finds the next identical concept, if any (block 4053).

If the concept is the initial concept or a defining leaf concept (block 4070), constraint [A6] is evaluated (block 4080) to determine if the subject concept has empty content and if so, if the defined concept is also empty. If valid, the subject concept is added to the defined concept's table of specific defining concepts. Constraint [A8] is evaluated (block 4082) to determine if a specified metric has one and only attribution association. If valid, the method finds the next identical concept, if any (block 4053).

If there are no more identical concepts (block 4054), the subject item_id is set to the first identical concept item_id (i.e., the concept that was used to find identical concepts). After excluding the case where there is more than one non-empty table of specific defining concepts for the subject concept (block 4091), constraint [A8] is evaluated (blocks 4092 and 4093). If valid, the list of defining specific concepts applicable each defined identical concept is applied to the undefined identical concepts (block 4094). The subject item_id is compared to the initial item_id (block 4095): if they are the same, the method is returned to the initial item and the method ends (block 4099); if not, the method returns to the parent Get and Validate Concepts method that initiated it (block 4101). Each error found generates a unique error message and sets valid to ‘no’ (block 4098) before ending the method (block 4099).

### E. Get and Validate Objects Method

The Get and Validate Objects method determines compliance with the following implicit constraints and generates an error messages if not in compliance. Those constraints are listed below described in terms of objects. The preceding bracketed letter and number are shown on the flowchart path followed when that error is found.
[B1] A structure cannot be recursive;
[B2] Identical objects must be defined by the same specific objects;
[B3] In order to be disjoint, a particular object cannot configure another object more than once either directly or indirectly through intermediate objects; and
[B4] In order to be disjoint, two objects immediately-defining an object can't be identical.

In addition to generating error messages and expressions, the Get and Validate Objects method determines: object subtypes based on concept comparison; object subtypes based on content, stored and deduced classes; and stored and deduced values.

One embodiment of the Get and Validate Objects method is illustrated in FIG. 37 and FIGS. 38A-C. This method starts (block 4110) when initiated by the Get and Validate Elements method. It is passed an initial item_id, a subject item_id that is set to be the same as the initial item_id and a configured item_id that is empty. The Generate List of Identical Items, block 4052, generates a list of identical concepts for the subject object, i.e., each object in an identity network; that list has only the subject item_id if there are no identical objects. The method finds the subject item_id and each object identical to it (block 4111). For each of these objects in turn, at block 4120, an object process A as shown in FIG. 38A is executed. The object process A initializes the subject item_id, creates an empty list of the specific (leaf) particular objects that directly or indirectly define the subject object and creates an empty table of the item_ids of the immediately-defining object applicable to the subject object containing the item_ids, 0-end expressions, class, object subtype based on identification (i.e., common or particular) and object subtype based on content (i.e., representational or internal) (block 4121). The object process A finds the class of the subject object (block 4122), calls the Get and Validate Value method (block 4046) for the attribution value to generate its item expression, generates and write a simplified value expression (block 4124). The object process A returns to FIG. 37 at block 4132, which finds the first object immediately defining the subject object (if any). For each defining object found, constraint [B1] is evaluated (block 4132) to determine if the immediately configuring item_id is equal to the initial item_id. If valid, at block 4140, an object process B as shown in FIG. 38B is executed. The object process B writes the 1-end association expression and the inverse item expression (block 4139) and then initializes by setting the configured item_id to the subject item_id and the subject item_id to the immediately configuring item_id (block 4141). Since a new object has been found, the object process B calls the Get and Validate Object method at block 4047, creating a child Get and Validate Object method. When the child method returns to the object process B, the object process B process determines whether the object is common or particular (block 4142) and whether the object is representational or internal (block 4143). It adds the entries in the subject object's list of specific particular defining objects to that of the configured object (block 4144) and adds the subject object's item_id to the configured object's table of immediately configuring objects (block 4145). The object process B writes a 0-end association expression for each of the of the subject configuration associations (there can be multiple configuration associations with the same directionality between two instances) based on the 1-end expression and reality of the configuring object, the configured object subtype, and association attributes (sn) (block 4146). The object process B also writes the 0-end implied value expression for each non-spatial attribution value of the configuring object (block 4147). If the object is particular (block 4148), the object process B adds the configured object's list of configuring particular objects (block 4149). The object process B returns the subject item_id and the configured item_id to their previous entries (block 4150). The object process B returns to FIG. 37 at block 4131, which finds the next immediately configuring object. The Get and Validate Object method determines whether there are additional immediately-configuring objects (block 4160) and, if not determines, whether or not any were found (block 4161). If none were found, constraint [B3] is evaluated (block 4162) to determine if the same particular object is found in the configured object's list of configuring particular objects more than once. If valid, at block 4163 the method determines if any two or more objects on the subject object's list of immediately-defining objects are also on any one of the lists of identical items for those objects. Constraint [B4] is evaluated based on that determination (block 4164). If valid, at block 4169, the Get and Validate Object method executes an object process C shown in FIG. 38C. At block 4170, the object process C adds each particular object in the configuring object's list of configuring particular objects to the configuring object's list of specific particular defining objects. The object process C determines the configuring instance concept and its subtype based on concept comparison (i.e., defined or product) at block 4171 and determines the configured object subtype based on content (i.e., representational or internal) at block 4172. The object process C writes the item expression for the subject object from its 0-end association expressions and reality (block 4173), writes the implied value expressions as the combination of the implied value 0-end association expressions if none of those expressions are missing (block 4174), and generates the simplified implied value expression, i.e., reduced to its simplest form (block 4175). The object process C returns to FIG. 37 at block 4181. If the subject object is not a product object (block 4181), the Get and Validate Object method writes the item expression in terms each of the defining specific (leaf) objects that directly or indirectly define the subject object included in the subject list (block 4182). The method finds the next identical object, if any (block 4111).

If the object is the initial object or a defining leaf object (block 4161), the subject object is added to the configured object's table of configuring objects (block 4180) and the method finds the next identical object, if any (block 4111).

If there are no more identical objects (block 4191), the subject item_id is set to the first identical object item_id (i.e., the object that was interrogated to find identical concept). After excluding the case where there is more than one non-empty table of specific defining objects for the subject object (block 4193), constraint [B2] is evaluated (blocks 194 and 195). If valid, the list of defining specific objects applicable each defined identical object is applied to the undefined identical object (block 4196). The subject item_id is compared to the initial item_id (block 4197): if they are the same, the method ends (block 4200); if not, the method returns to the parent Get and Validate Objects method that initiated it (block 4198). Each error found generates a unique error message and sets valid to ‘no’ (block 200) before ending the method.

### E. Duplicate/Query Method

The Duplicate/Query method implements two techniques: preventing duplicate objects (objects representing the same thing) from being entered; and querying (finding objects that match a search criteria). As described earlier, a query requests the system to find objects having characteristics of interest: class or subclass, reality, values and configuration with other objects. A query is specified in an I-A platform by adding a virtual object specified as having those characteristics. Whether the object was entered as an object in its own right or to initiate a query, the Duplicate/Query method finds all matching objects and adds object configuration associations from each of the matching object to the subject object. The results are reported differently depending on whether or not the subject object is virtual, and how many were found as described earlier.

One embodiment of the Duplicate/Query method is shown in FIG. 39. This method starts (block 4301) when initiated by the Validate method (4005 of FIG. 31), which passes the subject object item_id. Internal objects are omitted from the method (block 4302) as well as non-specific common objects (block 4303). Specific common objects and particular objects are treated differently based on the object subtype of the specific object (block 4303). The method for a specific common object finds the first stored object having the same class as the subject object (block 4304). The values of the stored object found are compared to those of the subject object (block 4305). If there are values with the same metric (block 4306), the comparison will result in either: the stored object has values for each metric that are either all the same or within the range of the subject object; or not (block 4307). If the former is the case, a configuration association is stored from the stored object to the subject object (block 4308). After adding the configuration association, or if there is no match, the method proceeds to the next stored object (block 4304) and continues until done (block 4309).

The method for a particular object finds the first stored object having the same class or subclass as the subject object (block 4315). The unique identification values (e.g., VIN) of the stored object or those of its product object (e.g., SSN) are compared to those of the subject object (block 4316). If there are values with the same metric (block 4317), the comparison will result in three possibilities: the comparable stored object's values are all the same; they are all different; or there is some combination thereof (block 4318). If the former is the case, a configuration association is stored from the stored object to the subject object (block 4319). If there is a combination of same and different values, an error message is generated and valid is set to ‘no’ (block 4329) and the method ends (block 4330). If they are all different or all the same, the method proceeds to the next stored object (block 4315) and continues until done (block 4320).

If no comparable unique identification values were found (block 4317), the method compares the non-unique identification values (e.g., Name) of the stored object to those of the subject object (block 4321).

If there are values with the same metric (block 4322), the comparison will result in three possibilities: the comparable stored object values are all the same; they are all different; or there is some combination thereof (block 4323). If the former is the case, a configuration association is stored from the stored object to the subject object (block 4319). If there are a combination of same and different values, an error message is generated and valid is set to ‘no’ (block 4329) and the method ends (block 4330). If they are all different or all the same, the method proceeds to the next stored object (block 4315) and continues until done (block 4320).

When no more stored objects are found for both a specific common object and a particular object, the method counts the stored objects defining the subject object (block 4324). The information conveyed by the subject object depends on the whether or not the subject object is virtual and the count of stored object defining the subject object (block 4325). As discussed earlier, if the added object is virtual, the output is a query result; if not virtual, the object is stored or there is an error report with a list of duplicates to be resolved in the Add, Delete and Edit Elements method.

If there is only one stored object that is a duplicate of the subject object, the system can automatically substitute the stored object for the subject item in the workspace. If the subject object is not deleted, any object that is subsequently added that meets the search criteria is automatically added as a defining object.

### F. Enforce Explicit Constraints Method

The Enforce Explicit Constraints method uses the expectational object information structures that specify constraints to identify objects that do not comply with that constraint (i.e., do not meet expectations). If found, an error message is sent to the Add, Change and Edit Elements method (block 4001 of FIG. 31). One embodiment of the Enforce Explicit Constraints method is shown in FIG. 40. This method starts (block 4401) when initiated by the Validate method (block 4005 of FIG. 31), which passes the subject object item_id. The method finds the first expectational object having the same class as the subject object. For each of the expectational object's values, the method determines if the range of values includes the subject object's value. If any one value is not in the specified range (block 4404), i.e., the object does not comply with the constraint, an error message is generated, valid is set to ‘no’ (block 4415) and the method ends (block 4416). If no values exceed the range, the method finds and generates a table with the subject object's product and member object with its class and count (block 4405). The method combines those entries in the table having the same class and updates the count so that each product and member object has a unique class along with a count (block 4406). The method finds the first entry in the table and finds the expectational object's product and member common objects having the same class or a superclass (block 4407). If found, the subject object's count of member or product objects is compared with that of the expectational object's count of those objects (block 4408). If any one count is not in the specified range (block 4409), i.e., the object does not comply with the constraint, an error message is generated, valid is set to ‘no’ (block 4415) and the method ends (block 4416). If no counts exceed the range, the method proceeds to the next expectational object (block 4402). When no more expectational objects are found (block 4411) the method ends (block 4416).

If a constraint is not met, the expectational object specifying that constraint can be modified to reflect the subject object or an additional expectational object can be added incorporating the expectation for the subject object.

The particular methods of the invention have been described in terms of software with reference to a series of flowcharts. The methods to be performed by a computer or machine constitute programs made up of machine-executable instructions illustrated as blocks (acts). Describing the methods by reference to a flowchart enables one skilled in the art to develop such programs including such instructions to carry out the methods on suitably configured machines (the processing unit of the machine executing the instructions from machine-readable media). The machine-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine causes the processor of the machine to perform an action or a produce a result. It will be appreciated that more or fewer processes may be incorporated into the methods as described above without departing from the scope of the invention, and that no particular order is implied by the arrangement of blocks shown and described herein.

### VII. Operating Environment

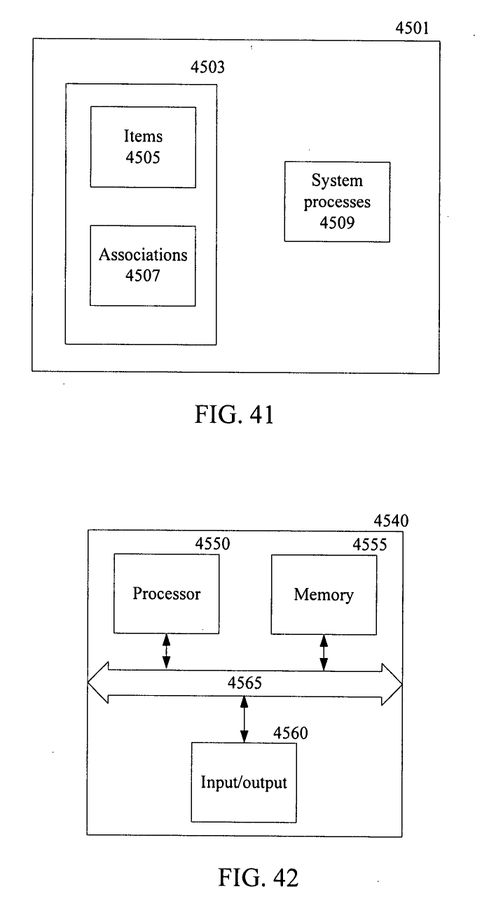

In one embodiment illustrated in FIG. 41, the I-A platform 4501 comprises electronic components including:
elements 4503 stored according to a storage model that conforms to the axioms of information; and
system processes 4509 that manage the elements 4503.
   The elements 4503 include items 4505 and associations 4507, as described above. The elements 4503 can store constraints, and physical and informational processes. The system processes 4509 can enforce any constrains stored in the elements 4503. The system process 4509 also can execute any informational processes stored in the elements 4503 to create elements specified as output from those information processes. The system processes 4509 include the methods described in section VI.

One embodiment of a computer system suitable for use as the I-A platform is illustrated in FIG. 42. The computer system 4540, includes a processor 4550, memory 4555 and input/output capability 4560 coupled to a system bus 4565. The memory 4555 is configured to store instructions which, when executed by the processor 4550, perform the methods and the system processes described herein. The memory 4555 may also store the storage model and informational structures. Input/output 4560 provides for input and output of data. Input/output 4560 also encompasses various types of computer-readable media, including any type of storage device that is accessible by the processor 4550. One of skill in the art will immediately recognize that the term “computer-readable medium/media” further encompasses a carrier wave that encodes a data signal.

The description of FIG. 42 is intended to provide an overview of computer hardware and other operating components suitable for implementing the invention, but is not intended to limit the applicable environments. It will be appreciated that the computer system 4540 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

### VIII. Conclusion

The prior art relational model freed users from having to know the internal representation (physical organization) of the information. An I-A platform described here takes additional steps in that direction: it frees developers, and users from:

having to know the external representation (logical organization), e.g., organization specified in a schema, file formats, data types, valid value listings and application logic;

needing to organize information around the ambiguous notion of an entity; and

having to base storage on or support a particular externally-specified representation of information, i.e., illustration convention or data type.

There are several additional characteristics and capabilities of an I-A platform that provide important utility.
1) Specification uniqueness: There is usually only one way to specify a given unit of information in a structure; where there is more than one way, the structures convey identical information. (This is comparable to a non-parametric equation whose alternative forms express the same mathematical relations). Once a structure having some utility has been specified, it can be published and directly used in other information platforms.
2) Specification completeness: A structure must completely specify the subject information: nothing can be omitted. For example, not only can a unit of measure be used to specify a quantity, it must be specified.
3) Mathematical rigor: The rigor found in mathematics similarly applies to information stored using an I-A platform through the axioms describing a fundamental understanding of information.
4) Inconsistencies: Any logical inconsistency in a structure can be found and the offending items can be specified as virtual and ignored.
5) Redundancies: Some structures allow redundant elements to be stored. The choice to store or not store a potentially redundant element conveys preference information.
6) Convention independence: Information is specified free of any illustration conventions and completeness insures that the information needed for any applicable illustration convention is available.
7) Concurrent process execution: The execution of both system processes and process stored as structures are readily partitioned for assignment to different processors for concurrent execution. Concurrent execution cannot generate invalid information because the management system finds and resolves any inconsistencies when information is changed.

An I-A platform as described herein provides a single basis for organizing and classifying all information types. The examples presented in the detailed description demonstrate its use is of considerable simplicity and elegance. An I-A platform appears to provide a basis for a foundational understanding of information itself.

For the information sciences as a whole, an I-A platform can provide a common language or illustration convention for describing information. For computer science, an I-A platform can alleviate long-standing problems in information management because:
1) a process is specified by an information structure rather than code;
2) it provides a common basis for sharing information;
3) it simplifies the integration of information across diverse platform implementations;
4) it eliminates the need to organize database information in a around the notion of an entity;
5) it enforces the relational database rules of normalization; and
6) eliminates ambiguity as to whether blank content is not applicable, unknown or is an empty bit string because: (1) content, including absence of any bits, is always applicable, and (2) unknown content is stored by the absence of an otherwise applicable item.

In addition to the above, an I-A platform simplifies the problem of partitioning the processes so that it can be concurrently executed in different processors.

For users and developers, an I-A platform implementation can alleviate the long-standing problems in information management summarized below.

Only one platform is needed to manage all information of interest to an organization, greatly reducing the number of ways that information is stored and languages that are supported.

Any incentive within an organization to develop one-off problem-specific applications, each usually inconsistent with all others, is eliminated.

The proliferation of different languages and means of storing information, along with updated versions, is curtailed.

A variety of complex information types (described earlier) are directly supported, i.e., without using application logic to specify how to interpret what is stored.

Platform implementations are updated by adding and deleting concepts and templates in the same manner as other information without the need to shut down the platform.

Application-specific shortcuts and conventions enabled by current platforms and languages are eliminated. A developer is constrained by principles that follow from a foundational understanding of information.

Two I-A platform implementations do not need conversion applications; an I-A Platform implementation, a non-I-A Platform implementation needs only two conversion applications: one to convert to and one to convert from an intermediate an I-A platform implementation.

Rather than designing and developing a completely new information system to integrate information spread across multiple systems within an organization, a new integrated system can be created simply by converting those systems to an I-A platform using the applicable conversion tools (described below).

On-line sites that publish structured information using an I-A platform can be queried simultaneously and the results retrieved. The results can be used without conversion and without concern for redundancy or record sequence. Publishing and retrieving structured information as described here parallels publishing and retrieving unstructured information using a search engine and browser.

Rather than writing code to store application logic tailored to a specific application in a specific language, logic stored as process structures can be readily found and used.

Rather than designing a database or ad hoc file format to store information, an I-A platform user can incorporate processes developed previously, either directly or consistent with the applicable pattern.

What is claimed is:

1. A method comprising:
storing information as an item and an association in a data structure, the item comprising a content attribute, and the association comprising a count attribute and a sign attribute, wherein the association represents a relationship between two items, and the data structure is an occurrence of a storage model that conforms to axioms of information that define characteristics common to all forms of information; and
generating output from the data structure in response to a query.

2. The method of claim 1, wherein the content attribute is a bit string having a length of one of zero or non-zero.

3. The method of claim 1, wherein an association further comprises a 1-end item and a 0-end item, the count attribute specifies a number of 1-end items associated with the 0-end item, and the sign attribute specifies inclusion of the 1-end item in the 0-end item, and wherein a null value represents an unknown condition.

4. The method of claim 3, wherein an association has a directionality defined by a creation sequence for the 1-end and 0-end items.

5. The method of claim 3, wherein an association is one of a non-configuration association and a configuration association, wherein a non-configuration association represents a relationship between two items with different item subtypes, and a configuration association represents a relationship between two items with the same item subtypes.

6. The method of claim 5, wherein two identical items are represented by two configuration associations that have a positive sign, and opposite directionality, and wherein the count is one when the items are instances.

7. The method of claim 3, wherein the 1-end item of an association is the same as the 0-end item and the sign attribute is positive if the item represents a real world item.

8. The method of claim 1, wherein storing information comprises:
modifying the data structure through one of adding, deleting and editing an element; and
validating an item modified by the add, delete and edit element process.

9. The method of claim 8, wherein validating comprises:
identifying an element subtype for the element;
validating according to the identified element subtype; and
enforcing explicit constraints on the identified element subtype.

10. The method of claim 8, wherein validating comprising:
determining if the element is a duplicate of an element already stored; and
discarding the duplicate element.

11. The method of claim 1, wherein storing information further comprising:
executing an informational process to generate a real object from a corresponding expectational object.

12. The method of claim 1, wherein a query comprises specifying a virtual object with characteristics corresponding to the query.

13. A computer-readable storage medium having stored thereon executable computer instructions to cause a computer to perform operations comprising:
storing information as an item and an association in a data structure, the item comprising a content attribute, and the association comprising a count attribute and a sign attribute, wherein the association represents a relationship between two items, and the data structure is an occurrence of a storage model that conforms to axioms of information that define characteristics common to all forms of information; and
generating output from the data structure in response to a query.

14. The computer-readable storage medium of claim 13, wherein the storing operation stores the content attribute as a bit string having a length of one of zero or non-zero.

15. The computer-readable storage medium of claim 13, wherein the storing operation stores an association as having a 1-end item and a 0-end item, stores a number of 1-end items associated with the 0-end item as the count attribute, and stores a value that specifies inclusion of the 1-end item in the 0-end item as the sign attribute, and wherein a null value represents an unknown condition.

16. The computer-readable storage medium of claim 15, wherein the storing operation further defines a directionality for an association as a creation sequence for the 1-end and 0-end items.

17. The computer-readable storage medium of claim 15, wherein an association is one of a non-configuration association and a configuration association, wherein the storing operation further stores a relationship between two items with different item subtypes as a non-configuration association, and stores a relationship between two items with the same item subtypes as a configuration association.

18. The method of claim 17, wherein the storing operation stores two identical items as two configuration associations that have a positive sign, and opposite directionality, and wherein the count is one when the items are instances.

19. The computer-readable storage medium of claim 15, wherein the storing operation stores a real world item as an association in which the 1-end item is the same as the 0-end item and the sign attribute is positive.

20. The computer-readable storage medium of claim 13, wherein the storing operation comprises:
modifying the data structure through one of adding, deleting and editing an element; and
validating an item modified by the add, delete and edit element process.

21. The computer-readable storage medium of claim 20, wherein the validating operation comprises:
identifying an element subtype for the element;
validating according to the identified element subtype; and
enforcing explicit constraints on the identified element subtype.

22. The computer-readable storage medium of claim 20, wherein the validating operation comprises:
determining if the element is a duplicate of an element already stored; and
discarding the duplicate element.

23. The computer-readable storage medium of claim 13, wherein the storing operation comprises:
executing an informational process to generate a real object from a corresponding expectational object.

24. The computer-readable stored medium of claim 13, wherein the generating operation comprises specifying a virtual object with characteristics corresponding to the query.

25. An apparatus comprising:
means for storing elements in a data structure of items and associations according to a storage model that conforms to axioms of information that define characteristics common to all forms of information; and
means for executing a system process on the elements to generate output from the data structure.

26. A computer-readable storage medium having stored thereon a data structure comprising:
a first field containing data representing a first item, including data representing a content attribute for the first item;
a second field containing data representing a second item, including data representing a content attribute for the second item;
a third field containing data representing an association, including a count attribute and a sign attribute, wherein the association represents a relationship between the first and second items; and
a fourth field containing instructions representing a system process that generates an output in response to a query specifying the data representing the first and second items and the association,
wherein the data structure is an occurrence of a storage model that conforms to axioms of information that define characteristics common to all forms of information.
